(19) United States
(12) Patent Application Publication
(10) Pub. No.: US 2026/0139786 A1
(43) Pub. Date: May 21, 2026

(54) ROBOTIC INLINE PIPE INSPECTION SYSTEM & APPARATUS

(71) Applicant: Northeast Gas Association, Parsippany, NJ (US)

(72) Inventors: Paul Laursen, Toronto (CA); Jonathan Warkentin, Toronto (CA)

(21) Appl. No.: 19/286,854

(22) Filed: Jul. 31, 2025

Related U.S. Application Data
(63) Continuation of application No. 17/924,513, now abandoned.
(60) Provisional application No. 62/705,489, filed on Jun. 30, 2020.

(51) Int. Cl. F16L 55/32; F16L 55/40; F16L 101/30

(52) U.S. Cl. CPC F16L 55/32; F16L 55/40; F16L 2101/30

(57) ABSTRACT

An autonomous robotic active gas-carrying pipeline testing system includes a remotely controlled robot assembly movable within the stream of gas flowing in the pipeline, wherein said gas flow exhibits dynamic flow energy, a miniature rotary turbine responsive to the gas flow, an electrical generator responsive to the turbine, a battery responsive to the generator, drive tow means responsive to the generator for moving the assembly, wherein the system is capable of harvesting said dynamic flow energy for either or both charging the battery and/or operating the drive tow means.

### TECHNICAL FIELD

This application relates to remote controlled robots for the inspection of the inner walls of natural gas pipelines and the like.

### BACKGROUND ART

Remote controlled robots for the inspection of the inner walls of natural gas pipelines and the like utilize one or more batteries, whose limited battery life requires a periodic need for re-charging. Robotic assemblies, or parts thereof, must be either removed or accessed, which requires an opening of part of the gas pipeline to access the batteries.

This fact, until the creation of the present invention by the undersigned inventors, has in this regard hampered more widespread and efficient use of such robots. The down-time necessary to more frequent re-charging of batteries translates to losses of inspection times and efficiency.

### DISCLOSURE OF THE INVENTION

In natural gas pipelines or the like, the gas or fluid flowing within pipes carries with it natural dynamic energy. It is an object of the present invention to harvest such dynamic energy associated with the flow of gas and to use it for either or both movement of the overall robot assembly and/or the charging of batteries. This is accomplished By means of at least one pressure drop-responsive turbine which requires relatively small psi pressure differential to autonomously drive an associated generator. All without the need to remove or gain access to robot batteries over relatively substantial functional periods of time. And all accomplished autonomously.

Another object and/or feature of the present invention is the provision of what will herein be referred to as a deployable and collapsible barrier, which is capable of autonomous control of the pressure drop across the barrier. The extremities of the barrier are automatically and autonomously adjustable such that they may in a substantially drag-free manner touch inner pipe walls or facilitate a gap between the barrier extremities and inner pipe walls. The battery, the barrier, the energy-harvesting turbine, and its associated generator function in association with one another, to harvest the dynamic gas flow energy and to use the harvested energy to drive the robot with a towing force within the pipe, and/or to charge the battery, as required. The present invention is capable of using the harvested gas flow energy to drive the robot assembly, without the need to drain energy from the battery.

Yet additional features and objects of the present invention involve provision of a novel automated computer-driven feature recognition capability which, among other things, includes inner pipe obstacle detection, bend detection, tee detection, and the presence of other pre-defined and non-pre-defined features.

The scope of the present invention contemplates the subject technology for use in inspecting pipes carrying natural and other gases, as well as other fluids and possibly liquids. It is also contemplated to utilize one or more types of sensing means, such as cameras.

It is hoped that the reader of this patent specification will appreciate that among the objects and goals of the present invention is to provide a novel and improved system and apparatus for reducing the operational complexity associated with prior art means for using robots to in-line inspect pipes of all kinds, such as, without limitation, pipes for the delivery of natural gas. This is accomplished using the novel method and apparatus according to the present invention.

Among the goals achieved using the present invention is the realization of an increase in robot range, a lowering of deployment costs, a reduction in the need for onsite personnel, an improvement in the quality of assessment pipeline data available, and a reinforcement of the robustness in robots used.

Furthermore, the present invention incorporates, in a preferred but not necessary embodiment, the use of an energy harvesting sub-system and apparatus, thereby enabling increases in longer-range wireless communications.

Among the inventions disclosed herein, the present invention teaches a novel new robotic inline inspection system and apparatus, for the inspection of, for example only, “unpiggable” natural gas pipelines of a variety of sizes. It is preferred, but not necessary for this application, to focus upon pipe diameters of from 6 inches to 36 inches, without departing from the scope and spirit of the invention.

The present invention represents the latest in the ongoing evolution of development of robots capable of successfully performing in this environment. For example, the significant efforts of InvoDane Engineering and the Northeast Gas Association in this regard must be acknowledged here.

While the inventors have chosen to use the term “unpiggable” in this specification, it is acknowledged that this term and its use have not been without controversy. The Pipeline Research Council International (PRCI) has decided to discourage the use thereof. Suffice it to say that the present invention is capable of fully functioning within aging pipelines which were not designed for in-line inspection and which, therefore, have one or more types of difficulty or unknowns. Such older pipelines have in many places succumbed to erosion and corrosion.

This invention facilitates provision of a safe pipeline integrity management system for use with unpiggable pipelines, whose very nature presents challenges that include access difficulties as well as recurring damage mechanisms. This is accomplished without the need for any changes in pipeline configurations. The system by its nature provides for safe and easy robot launching and seamless execution.

The present invention provides a long-range robot that is capable of staying in pipes far longer than those known to the art, and that can travel farther and with less operator control or input. This permits superior collection of highly valuable pipeline information.

A significant preferred embodiment of the present invention includes provision of what is herein called an energy-harvesting system. This embodiment enables a robot to actually utilize flow of, for example, natural gas within the pipeline to both tow and charge the robot. While natural gas is presented as an example of such flow, the present invention contemplates the use of such energy-harvesting with any number of gases and/or fluids, without departing from the scope or spirit of the invention.

Additionally, the present invention teaches the placement of a robot within a pipeline which is capable of being pre-programmed to an end point, such that the amount of time that the robot is within the pipeline is increased. This permits longer inspection runs, less excavation, and reductions in personnel costs.

Another significant feature and focus of this invention is the provision of increases in the autonomous operation of the robot. This permits reductions in “hand on” roles of highly trained personnel, which has been known to lead to inconsistent and less efficient control of the robot. This feature further permits reduction or elimination of full robot monitoring, as well as wireless communication bandwidths. And the time and energy required to train and maintain an “army” of trained personnel is virtually reduced or eliminated.

It is further contemplated by this invention to provide computer automation, feature recognition, drive-assist, mapping of pipelines, and full system testing and evaluation.

### BRIEF DESCRIPTION OF THE DRAWINGS

FIG. 1 is an illustration in side elevation of a robotic system according to the present invention;

FIG. 2 is another illustration of a robotic system, wherein the turbine, generator and barrier are labelled;

FIG. 3A is a perspective illustration of the generator turbine and barrier according to the present invention;

FIG. 3B is a sectional end view of the components of FIG. 3A;

FIG. 4 is a schematic diagram of components of the present invention;

FIG. 5 is a schematic view similar to FIG. 4;

FIG. 6 is an illustration of robotic drive wheels and their deployment;

FIG. 7 is an illustration of the collapsible barrier according to the present invention, shown in both collapsed and deployed configuration;

FIG. 8 is a perspective illustration of the regulator and turbine outlets of the robotic system;

FIG. 9 is an illustration of modules of the present invention, in collapsed and deployed configuration, and illustrating the modular design of the invention;

FIG. 10 illustrates the damper plate of the invention, shown in relation to the flow of gas in the piping carrying natural gas;

FIG. 11 is an alternative view of the damper plate of FIG. 10;

FIG. 12 illustrates the pressure regulator feature of the present invention;

FIG. 13 is a perspective illustration of the pressure regulator mechanism of the invention;

FIG. 14. Is a side sectional elevational view of the regulator mechanism of FIG. 13;

FIG. 15 illustrates in schematic fashion the pressure regulator valve operation of a preferred embodiment of the present invention;

FIG. 16 illustrates in a perspective three-dimensional view the turbine module according to the present invention;

FIG. 17 is a side sectional view of the module of FIG. 16;

FIG. 18 is a collection of view of the barrier module, collapsed and deployed, according to the present invention;

FIG. 19 a perspective illustration of the 3D stereoscopic camera according to the present invention;

FIG. 20 illustrates a disparity map, illustrating what the camera of FIG. 19 sees within a gas-carrying gas pipe;

FIG. 21 is an illustration of the noise threshold establishment according to the present invention;

FIG. 22 illustrates the pipe bend detection facilitated by the invention, as the robot travels within a gas pipe;

FIG. 23 illustrates the ability of the robotic system of the present invention to detect and inspect pipe tees;

FIG. 24 is an illustration of pipeline mapping output enabled by the present invention;

FIG. 25 illustrates GPS location measurement capability of the invention;

FIG. 26 the nature of how the location of the robotic system of the invention is enabled utilizing gravity vector measurements;

FIG. 27 illustrates the mounting of an IMU unit as part of the robotic system of the invention;

FIG. 28 illustrates in schematic fashion a pipeline overview used with gyro-compassing;

FIG. 29 is a sectional elevation view of a plug valve according to the present invention;

FIGS. 30-33 illustrate a robotic plug configuration according to this invention;

FIG. 34 illustrates in a perspective view a drive module according to the present invention;

FIG. 35 illustrates drive tracks with wheels, according to the invention;

FIG. 36 illustrates an odometer wheel on a drive track, in the invention;

FIG. 37 illustrates in side elevational schematic an actuator that presses drive tracks against an inner pipe wall;

FIG. 38 illustrates in schematic view a drive wheel, hub and tire according to the invention;

FIG. 39 illustrates the distribution of batteries of the invention;

FIGS. 40-44 illustrate in an exploded-type view robotic components of the invention;

FIG. 45 is a perspective-type illustration of an assembled robotic system according to the present invention;

FIGS. 46-51 illustrate a pipe cleaning component of the robotic system, in relation to the pipeline to be cleaned;

FIGS. 52-59 illustrates wire brush and sanding components used in the pipe-cleaning module of FIGS. 46-51; and

FIGS. 60-84 illustrate pipeline cleaning apparatus capable of being incorporated into the robotic system according to the present invention.

### DESCRIPTION OF THE EMBODIMENTS

### Energy Harvesting Feature:

One of the main objectives of this invention is to provide a module with energy harvesting capabilities to the robot. As used herein, the term “energy harvesting” is meant to include the harvesting of energy from the very gas flow within the pipeline to be inspected. Such a module has been designed to be integrated onto robots that will operate within pipelines of inner diameters of, for example but without limitation, 20 and 26 inches.

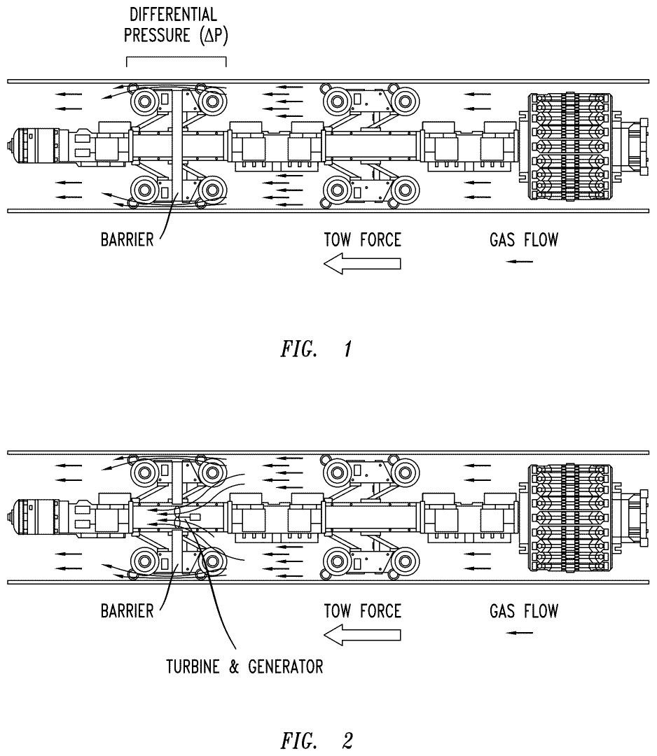

This approach relies in part upon the creation of a differential pressure across the robot. To create this differential pressure, the robot has the ability to restrict and regulate gas flow around it. The build-up of this differential pressure generates a tow force in the direction of the flow, as illustrated in. When the robot travels travelling in the direction of gas flow, the tow force results in lower power consumption of the drive modules. To further reduce battery consumption and to be able to charge the robot batteries using gas flow, electrical power needs to be generated. This is facilitated by the addition of a turbine attached to a generator, as shown in FIG. 2.

Target Requirements: Table 1 below sets forth target requirements and expected operating range.

TABLE 1

| | | |
|---|---|---|
| Parameter | Target Requirement | Expected Operating Range |

| | | | |
|---|---|---|---|
| Pipeline Flow Speed | 2 | ft/s | 1 ft/s to 25 ft/s |
| Pipeline Pressure | 200 | psi | ≤750 psi |
| Turbine Speed | 6000 | rpm | 4000 rpm to 8000 rpm |
| Turbine Power | 600 | W | 200 W to 1000 W |
| Differential Pressure (ΔP) | 2 | psi | 0.5 psi to 2.5 psi |

The energy harvesting module is essentially a drive module with the following features added to it: (a) a mechanism to restrict flow in order to build up differential pressure (barrier); (b) a mechanism to safely regulate differential pressure; and (c) a mechanism to generate electrical power (turbine) from gas flow.

In addition, the energy harvesting module has been designed to: (a) stay in control of the robot's travelling speed in all operating modes; (b) incorporate additional fail-safes; (c) increase drive force to compensate for additional weight; (d) exhibit reliability and ease of servicing; and (e) minimize operational impact—for example, if the MFL sensing section can traverse a bend without the need to be collapsed then so should the energy harvesting module.

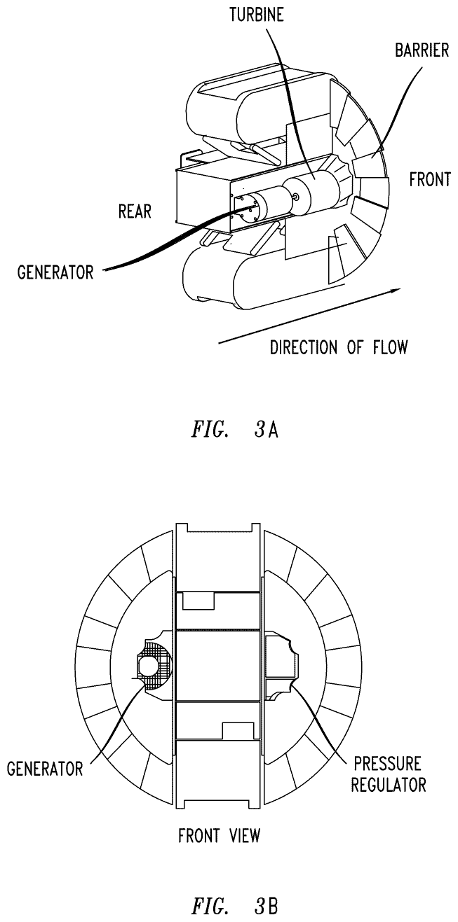

Energy Harvesting Module Design: The present invention contemplates a custom drive module capable of housing the required mechanisms for energy harvesting. FIGS. 3A and 3B illustrate an embodiment of such a module. The systems added to the drive module provide a barrier which can be expanded to increase flow blockage or retracted to decrease flow blockage. A turbine module is attached on one side of the energy harvesting module for electrical power generation, and a pressure regulator module is attached on the opposite side for fine tuning the differential pressure, as well as for overpressure relief.

Under what will be described here as a Phase I approach, according to an embodiment of the present invention, a barrier system is provided for coarse differential pressure and power regulation, an electrical load for fine power regulation, and a passive pressure relief system for transient management. Optimization provides miniaturizing so as to enable fitting the robot with the module. In a Phase II approach, optimization of the system enables a modified control approach.

More specifically, for the Phase I approach, the differential pressure control is accomplished using a barrier. The barrier's activation is relatively slow, and the barrier is not particularly accurate, linear, or steady in its regulation.

An adjustable pressure regulator valve is used for coarse differential pressure adjustments. Where the pressure regulator is operating at the limits of its flow capability, the barrier position is adjusted to create a more favorable flow condition for the regulator.

The pressure regulator still acts as a passive pressure relief for flow transients. The pressure regulator still acts as a passive pressure relief for flow transients. And where differential pressure exceeds the set-point, it will increase the opening area until the differential pressure returns to the set-point.

For power regulation, the only power needed is taken from the generator, instead of dumping excess power as heat. This serves to significantly reduce electrical shunt size, and it also reduces mechanical and thermal stresses on the generator.

Travel speed management is accomplished via a “Cruise Control” system that monitors the robot's set travel speed. Using travel speed management, if the robot is travelling too slowly, it will cause the control loop to increase differential pressure to increase tow forces. On the other hand, if the robot is travelling too quickly, it will decrease the differential pressure to reduce tow forces.

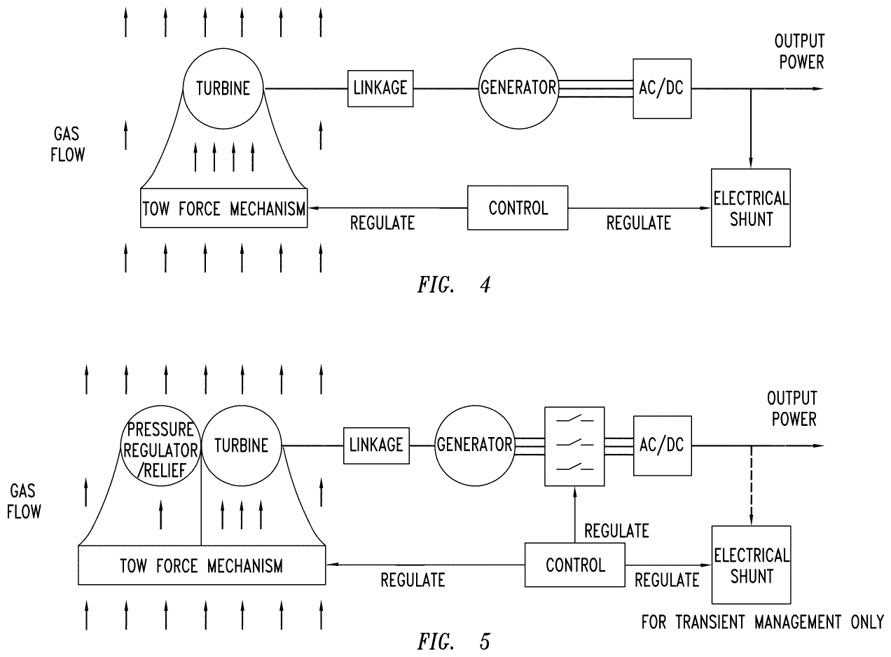

FIG. 4 illustrates the Phase I control approach from Phase I, while FIG. 5 illustrates a modified Phase II approach.

In the Phase I approach, the barrier was used to coarsely control the differential pressure and the resulting power output. A large resistor bank (electrical shunt) dissipates excess electrical power to help regulate power down to the levels required by the robot.

In the Phase II approach, a pressure regulator valve is used to finely tune the differential pressure instead of the barrier, and power regulation is largely accomplished by taking only what is needed from the generator, thereby enabling a reduction in the size of the electrical shunt.

### Modular Drive Portion:

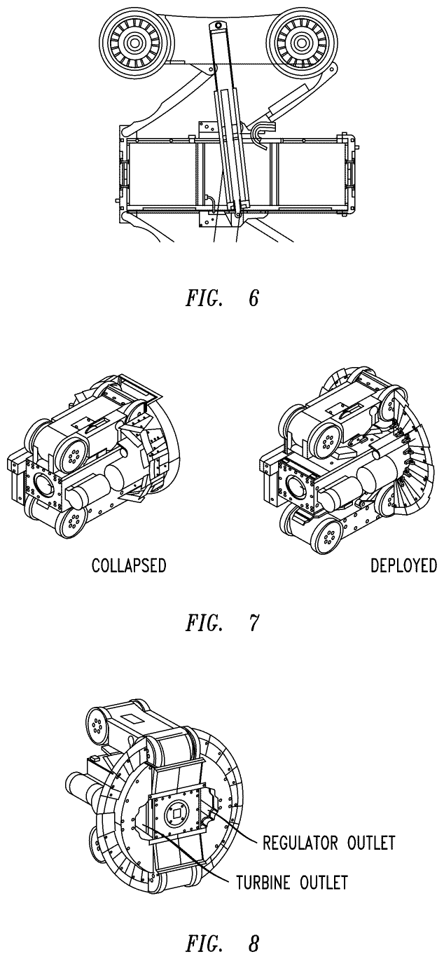

The drive portion of the module has been designed to adapt from 24 inch to 26 inch pipes. The deploy force has been designed to compensate for the additional module weight. FIG. 6 illustrates in a sectional view the drive track deploy mechanism according to this invention.

In FIG. 7, the complete energy harvesting module presented by this invention can be seen in both the collapsed and deployed modes (drive tracks and barrier). FIG. 8 illustrates a “front” view of the module with the flow outlets for the turbine and the pressure regulator valve depicted.

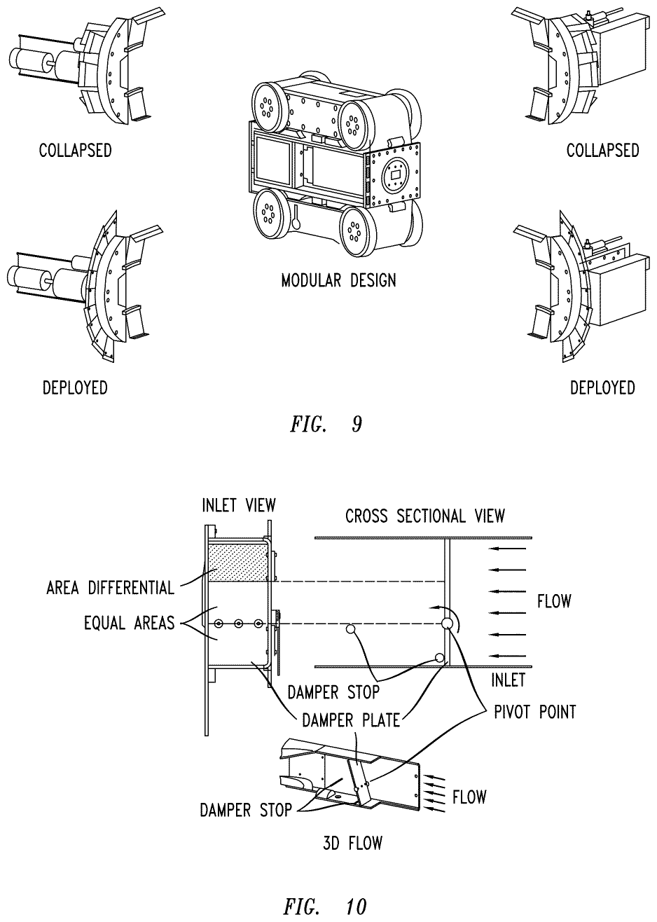

To enable ease of servicing, the energy harvesting module itself has been designed to be substantially modular. The turbine module, pressure regulator module, and barrier modules are able to be swapped out for servicing or to adapt to different pipeline diameters (see FIG. 9).

The modules are designed with connectors which establish electrical connections automatically when a module is mounted. This eliminates the need for managing connectors and cables during servicing, and also significantly reduces the risk of damaging wires or missed connectors.

### Regulator Module:

A regulator module is designed to control and limit the differential pressure across the energy harvesting module. The area differential across the damper with respect to the pivot point (see FIG. 10) is balanced with the torque applied to the pivot point to determine the valve open area. Differential pressure greater than the set-point will cause the valve to open further whereas pressure less than the set-point will cause the valve to close. The mechanism is designed to operate from 0.5 psi to 2.5 psi. As the pressure at the inlet increases above the set-point, a damper plate rotates to allow this increased pressure to escape.

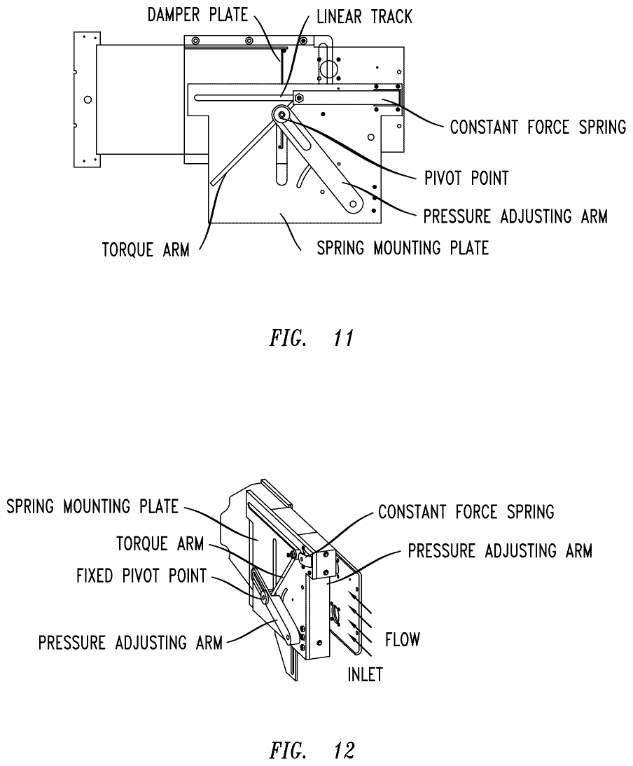

Earlier design efforts directed to pressure regulator parts, illustrated in FIGS. 11 (side view) and 12 (3D view), were based upon having a damper with a constant force spring. These efforts were replaced after it was discovered that the mechanism was too sensitive to friction and had a tendency to jam.

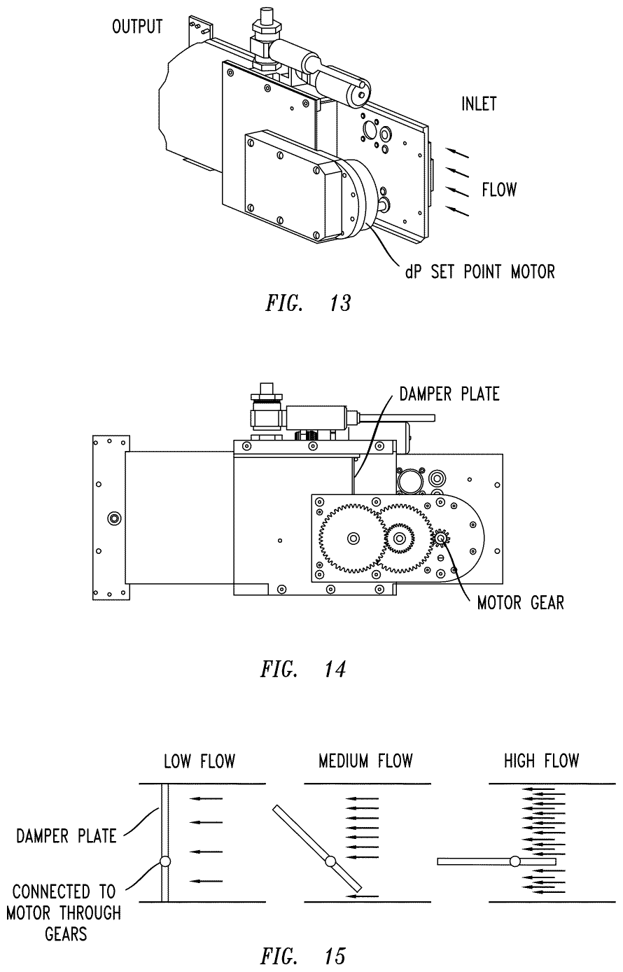

The pressure regulator mechanism in its current design uses a motor, instead of a spring with sliding arms, to fine tune the amount of bypass. This mechanism (illustrated in FIGS. 13 and 14) is beneficially simple with less moving parts. It is able to fit in the same solution space as earlier designs. In order to hold the damper plate in place power is required. This means that during a power failure it would fail safe and the flow would push the damper plate into an open position. The power consumption reduces the energy harvesting efficiency slightly, by approximately 0.6 W, at the minimum differential pressure target and by 15 W at the maximum differential pressure target. Such efficiency losses, however, are considered negligible when compared to the overall power generated.

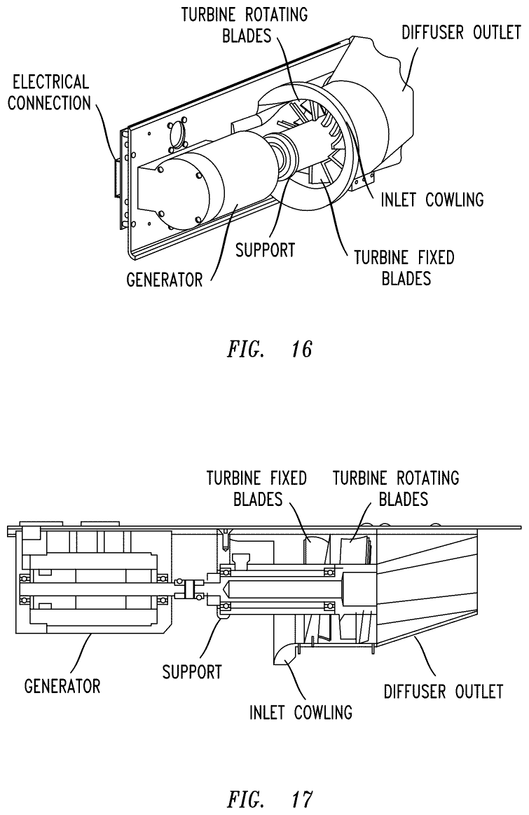

FIG. 15 illustrates the pressure regulator valve operation in a preferred embodiment.

### Turbine Module:

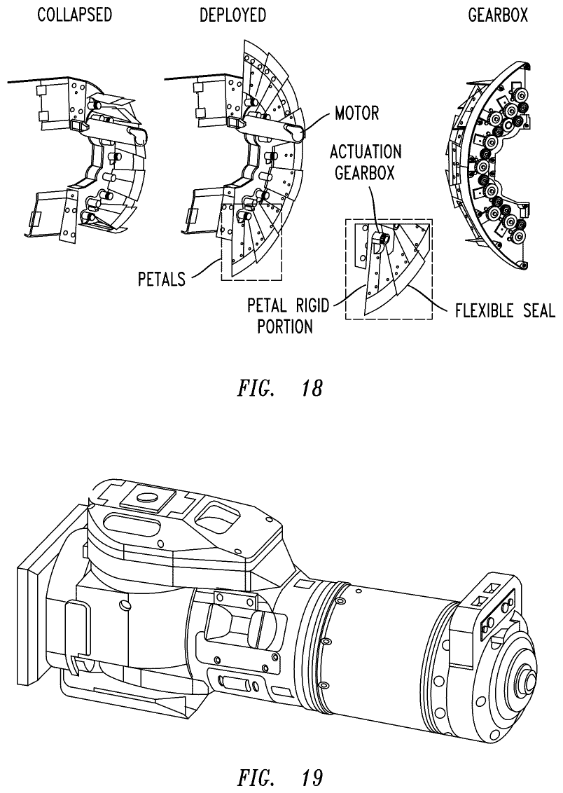

A turbine module according to the present invention is illustrated in FIG. 16, and consists of a turbine and generator, inter-connected by a shaft and supported by ball bearings. The turbine is comprised of a set of fixed blades and rotating blades with an inlet cowling and diffuser outlet. Electrical connections are made automatically when the turbine module is installed on the robot's energy harvesting module. FIG. 17 is a cross-sectional view of the turbine module.

### Barrier Module:

A purpose of the barrier module is to restrict the flow bypassing the module, thereby increasing flow through the turbine. This module is comprised of two halves, each with a motor driving a set of petals. The petals contain a flexible outer seal which changes shape to contact the pipe surface, and a rigid portion attached to the actuation gearbox. As the motor turns, gears transfer the motion simultaneously to the actuation gearboxes to rotate the petals from a collapsed position to a deployed position, as illustrated in FIG. 18.

### Computer Automation:

It is recognized that relatively complex data processing is required for robot automation. With this in mind, the present invention provides a robot onboard “main” computer which is capable of increased processing power that enables automation.

Proprietary electronics are interconnected between what will herein be referred to as an automation computer and robot power and communication buses. Computers, as well as their associated active heat sinks, are supported by control modules.

The automation computer system according to this invention is capable of processing video signals and data from a stereoscopic camera, as well as from robot sensors. With respect to the stereoscopic camera, the reader is referred to the discussion below directed to feature recognition. With respect to the robot sensors, these sensors enable the sensing of signals from joint angles and wheel speeds, for example and without limitation. The automation computer further permits the directing of the robot (as a whole) through a number of features and capabilities, which are referred to below with respect to an assisted drive.

### Feature Recognition:

Feature recognition is a highly desired feature in the type of robots contemplated by the present invention. Prior art robotic camera systems are unable to provide the meaningful quality and accurate output needed for usable feature recognition.

The present invention provides a three-dimensional (3D) stereoscopic camera that is situated slightly off-center from the robot's longitudinal axis, supported by a control module. (See FIG. 19).

In a preferred embodiment, the stereoscopic camera of this invention captures two (2) independent images from camera sensors that are separated from one another by 50 mm. An intensity map is created from calculations whereby these two images are compared with one another, pixel by pixel. The intensity map, in turn, provides a disparity may illustrating an apparent motion of each pixel associated with the two images. An infrared (IR) pattern, invisible to the human eye, is projected by the stereoscopic camera, in environments such as in pipelines, where there is low contrast.

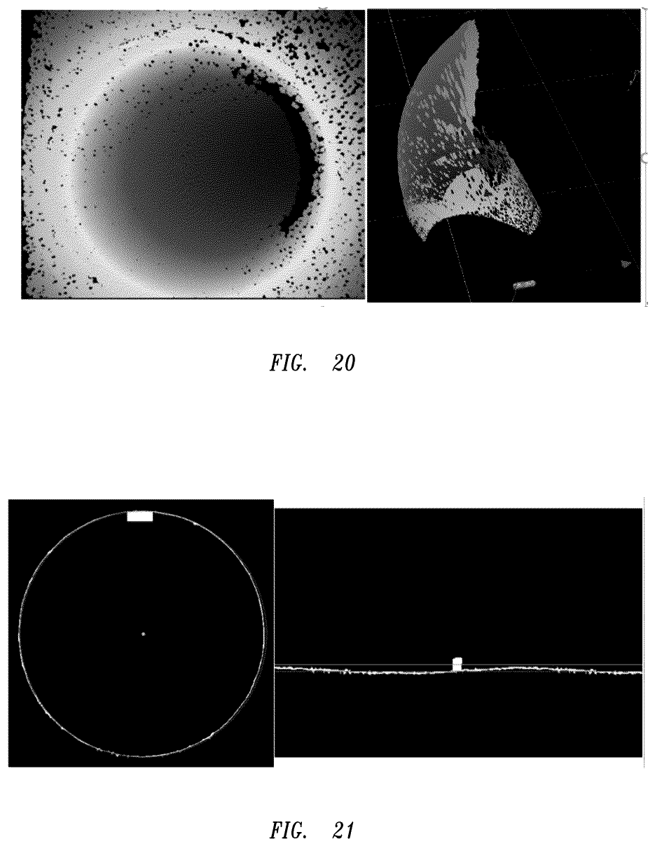

By knowing the geometry of the camera sensors, as well as the field of view of the camera lenses, the said disparity map that has been created is, itself, converted into a three-dimensional cloud or a 3D representation of the pipeline being photographed. FIG. 20 illustrates a disparity map on the left, and a point cloud on the right, for a scan of a ninety (90) degree bend in a pipeline, as the robot approaches the bend.

The present invention contemplates feature detection algorithms capable of utilizing the aforementioned point clouds as a source of input data. Time and space-type filters are utilized to minimize or eliminate point cloud noise, prior to being utilized in the processing step(s).

### Pipeline Detection:

A first step in obtaining feature detection data is to determine the orientation of the robot camera, with respect to the pipeline geometry. This is accomplished making and using overhead and side view projections. Pipe edges are located. In order to remove camera pitch from a pipeline representation, the aforementioned point cloud is thereafter rotated such that it is relatively coaxial with the pipeline. This will provide approximately one degree accuracy.

Once the point cloud is co-axially aligned with the pipeline, a series of projections enable a calculation of minimum and maximum pipe diameter. This alignment further allows a calculation of any ovality of the pipeline. In a final step, axial projection is performed, to fit the aligned pipeline to a circle T.

### Obstacle Detection:

The present invention includes a novel capacity and method of detecting obstacles in a pipeline. This is accomplished utilizing the point cloud described above. The obstacle detection method preferably begins with fitting a circle to the axial projection of the point cloud. Instead of plotting occurring using Cartesian coordinates, polar transformation begins by cutting the circle at the top and rolled out. See the left side of FIG. 21. A noise threshold is established so that any protrusions that extend beyond that threshold are classified as obstacles. See the right side of FIG. 21.

### Bend Detection:

Detecting pipeline bends is relatively complex, since not only is it required to detect the presence of a bend, but an accurate bend plane and center path are required to be established in order to correctly align the robot.

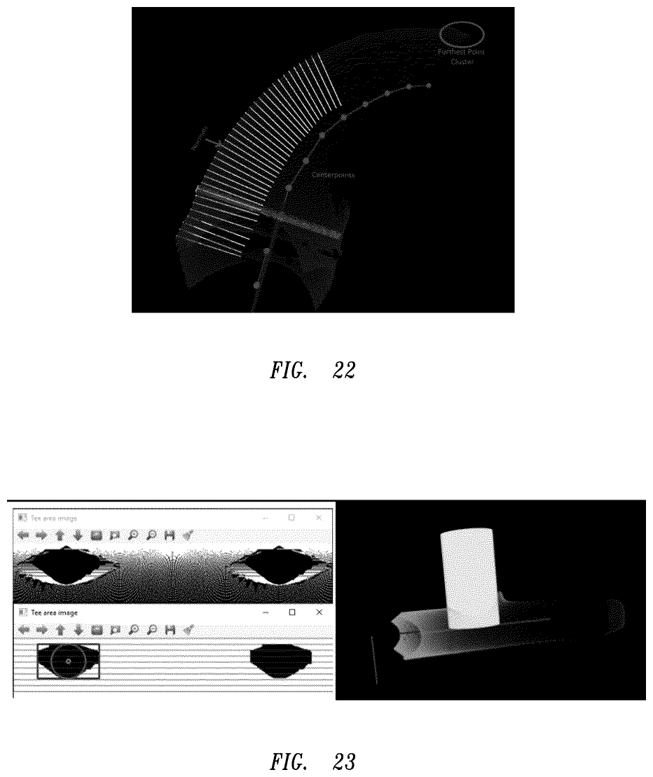

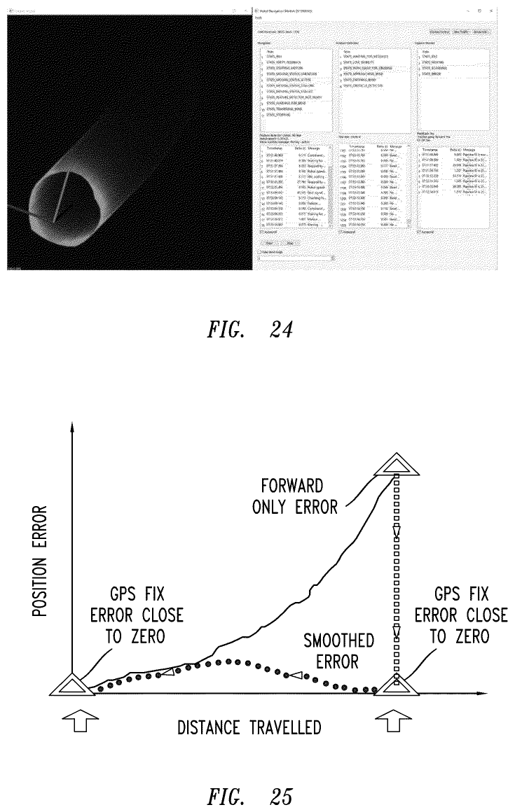

Once both the presence of a bend and the bend plane are determined, center points must be established through measurements. The above-referenced point cloud is rotated until the bend is illustrated to be horizontal (at zero degrees), and an overhead projection is made. This invention utilizes a line-following image processing algorithm to detect the outer edge of the pipe, and a known radius is projected inwardly. Three-dimensional center points that are required for navigation are generated. To enable navigation, two-dimensional points are rotated in three-dimensional space utilizing the angle found in the previous step. See FIG. 22.

### Tee Detection:

Pipeline inspection utilizing a robot, in accordance with the present invention, requires dealing with pipeline tees. Tee inspection begins with an axially-aligned point cloud. This cloud is cut and rolled out, as seen in the upper portion of the left side of FIG. 23. Holes in the point cloud are identified and sized, as illustrated in the lower portion of the left side of FIG. 23.

### Assisted Drive:

This invention incorporates what is herein referred to as an assisted drive method and apparatus. Novel refinements to existing drive assist software are incorporated, based upon real world conditions. This includes software control means as well as the use of a novel navigation control module, as described below.

Drive assist software according to the present invention is able to be controlled by signals or messages sent from either a local or remote controller. It is compiled to run on the automation computer referred to above.

A navigation module controls the robot via the aforesaid drive assist by means of feedback from robot sensors and the feature recognition module. The navigation module is a rules-based, overarching state machine, in controlling the robot. It is able to be run on a desktop or laptop computer, is able to control an Explorer simulator or on an automation computer of the type described above.

It is a goal of this invention to provide a navigation module which enables far simpler control that conventional systems. Instead of actuating individual joints, adjusting throttle, viewing video to identify upcoming features and reacting to them, the use of the present invention is able to enter a desired speed. The software of this invention autonomously ensures that it is safe to proceed, by verifying that all feedback from the robot and the feature recognition module is correct.

In the event robot feedback is unreliable or if something appears wrong (such as, by way of example only, if the throttle is too high for the current speed set-point, or if the joints are deployed too far for the current radius, the software of this invention will stop the robot and will await further instructions from the operator.

If features are detected by the feature recognition module, the navigation module is able to appropriately react to them. In cases where features do not require user input (such as, for example, in bends), this software will ensure that the robot is aligned correctly with respect to the plane of the bend, and it will proceed through it by following three-dimensional center points.

There are features which require user decisions, such as when encountering tees. In such cases, the software of this invention will stop the robot until further instructions are received.

Unsafe conditions can be detected by the invention's feature recognition capability. Such conditions may include, by way of example only, the presence of relatively large obstacles or obstructions, or no recognizable pipeline. In such instances, control is transferred to the user of the system.

### Pipeline Mapping:

Pipeline mapping capabilities are provided by the present invention. This is accomplished, at least in part, by provision of an inertial measurement unit (IMU) supported by the robot. Techniques are provided to post-process IMU data using survey data for accurate mapping.

Data is collected at relatively high rates from the IMU (such as 1 kHz). Electronics, which are supported by the robot, communicate on the bus such that data to memory and upload are logged, thereby permitting processing. Such processing of IMU data relies upon a Kalman filter. Kalman filtering may be defined as an algorithm that is able to provide estimates of unknown variables. In this invention, the algorithm uses a series of measurements, observed over time, with an assumed statistical noise model, to create estimates which tend to be better than the taking of each single measurement. The filter is used to predict the next state, such as position, velocity, orientation, scale and bias of various IMU measurements. Such predictions are updated as new data is obtained, such as via GPS updates or an odometer.

In real world pipeline mapping, GPS updates are provided with above ground markers (AGMs), which are placed above an underground pipeline at predetermined locations. The AGMs monitor for magnetic disturbances created by the passage of an inspection tool, keyed to a logged accurate timestamp. Relying upon accurate timestamps, these two are able to be later correlated and a GPS update is able to be applied to post-process the IMU data.

To mimic real world application, in testing GPS updates are limited to a frequency similar to that which would be available from AGM placements, or every 500 to 1000 feet, for example.

An odometer wheel mounted upon a test cart provides a simulation of odometers which have been available on prior art pipeline inspection robots. Continuous 10 Hz updates are provided that are accurate to 1%. Since an odometer does not provide absolute information, it is fed into the Kalman filter, to serve as a correction of the estimated velocity.

Due to a lack of absolute measurements between GPS updates, as well as inherent inaccuracies and noise in IMU and odometer readings, estimated position will grow over time, as illustrated in FIG. 25. Since IMU processing is not done in real time, future GPS updates are used to aid in reducing positional errors. To accomplish this, the present invention rotates IMU/odometer measurements 180 degrees. Data is run through the filter in reversed time, from the last sample to the first. The filter estimates not only the position, but the variance of the position. In this way, the forward and reverse pass through the filter to enable a weighting by the estimated variance and can be optimally combined.

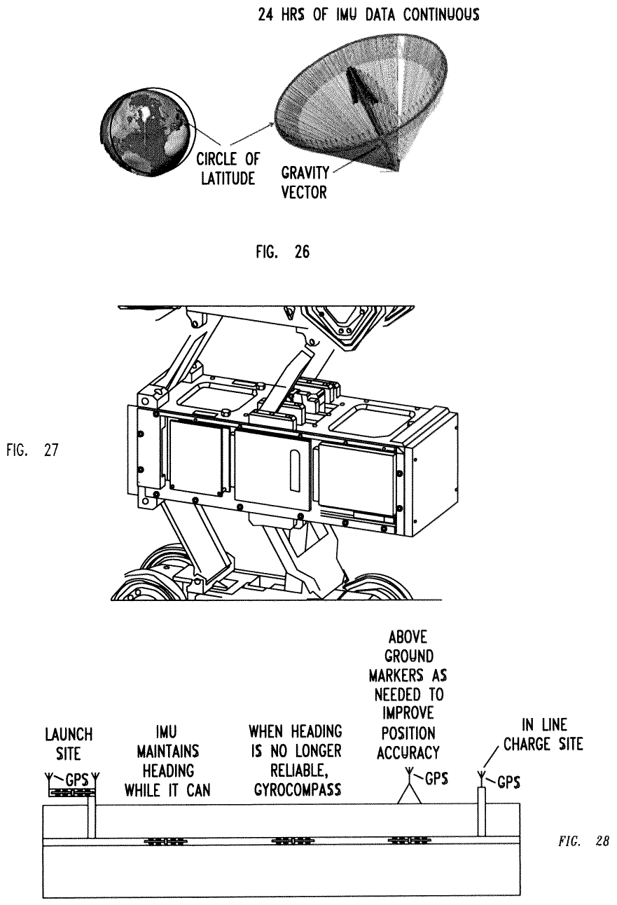

Additional, optional, accuracy is available, through the use of the correction for heading errors. Then stationary, the IMU only detects the rotation of the Earth and the acceleration due to gravity. By rotating the gravity vector with respect to the rotation of the Earth, an estimated circle of latitude is obtained. See FIG. 26. Knowing the direction of the rotation of the Earth and the gravity vector, the bearing of the device (angle from North) is calculated. The accuracy of this calculation is dependent upon the duration of time spend stationary. Approximately 2% accuracy can be achieved from 20 minutes of data, for example. The term “gyrocompassing” is adopted here to denote the periodic use thereof to correct for heading errors.

### Mounting on Robot

The present invention includes provision of a mount supported by the robot, to accommodate the aforesaid IMU, logging electronics, and a relatively small backup battery located in a battery compartment of the robot's drive module. See FIG. 27 which illustrates an IMU mounted on a robot.

### The Mapping Process

In basic terms, prior to the start of a robot inspection, the location and heading of the launch site is surveyed. The robot is deployed and IMU data is logged. After a pre-defined distance, or after a bend, the robot is stopped to allow for gyrocompassing. Above-ground markers (AGMs) are placed as needed, to improve accuracy. FIG. 28 represents an attempt to illustrate in schematic form this pipeline overview.

### Plug Valve Navigation & Functionality:

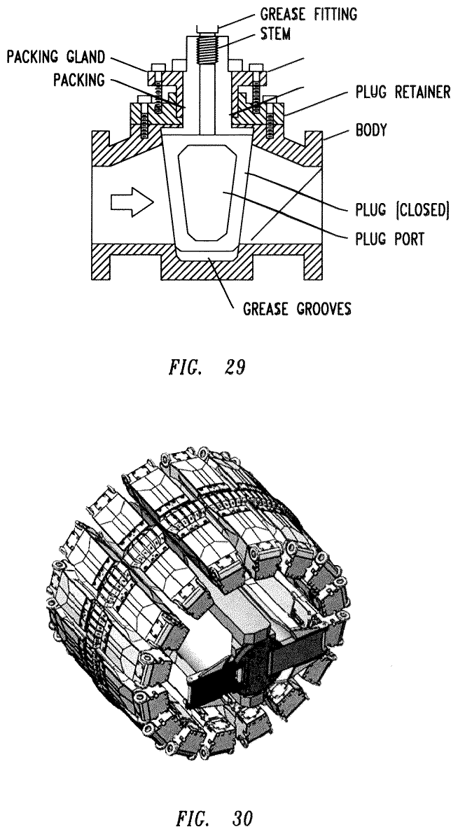

It is known that robots will and must operate in pipeline environments which include plug valves capable of stopping and permitting the flow of gas therein. Crudely speaking, such plug valves may include a plug formed with a port therethrough secured to a valve stem through one or more fittings to an operating handle. The plug is disposed within the flow of gas such that, by turning the valve handle, the plug's port is able to stop, enable or control the flow of gas. Of course, the very presence of the plug and its port creates a reduced-diameter port obstacle in the desired path of the robot. The port diameter or opening is necessarily smaller than the inner diameter of the pipeline into which the plug valve has been installed. FIG. 29 illustrates in partial cross-sectional schematic view a conventional-type plug valve, not necessarily used with gas pipelines, with an elongated port in its plug.

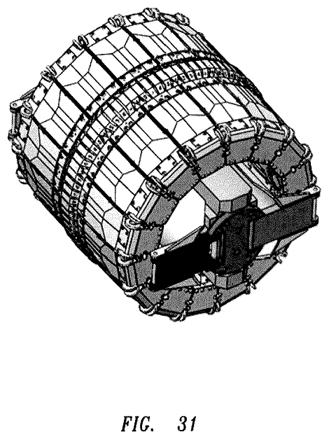

The present invention provides, in FIGS. 30-33, a robotic plug configuration module, armed with a plurality of magnet bars arranged in expandable fashion around a central body. In the initial state shown in FIG. 30, these magnet bars are inactivated such that the central body may be positioned relatively close to or at the center of the pipeline carrying the robot. FIG. 31, the magnet bars are collapsed to approximately seventy five percent (75%) of the inside diameter of the pipeline. Latches located at the ends of the central body are engaged.

In FIG. 32, the latches are released such that when the robot is driven forward. The banks of the magnet bars that are slidably mounted to a slide member, are permitted to extend outwardly to the front and rear of the module, thereby elongating the overall length of the module approximately 250%.

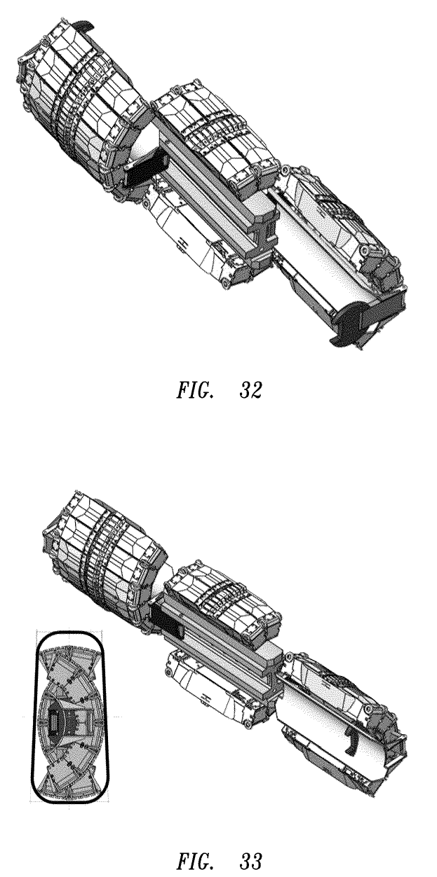

FIG. 32 illustrates the axial location of the magnet bars at the ends of the slide member, such that they may at this point realize hinged movement about the ends of the central body, thereby reducing the overall diameter of the module so that it may be pulled or moved through the port of the plug in the plug valve. FIG. 33 illustrates in an axial view the module in its reduced diameter configuration.

### A Preferred Drive System Embodiment:

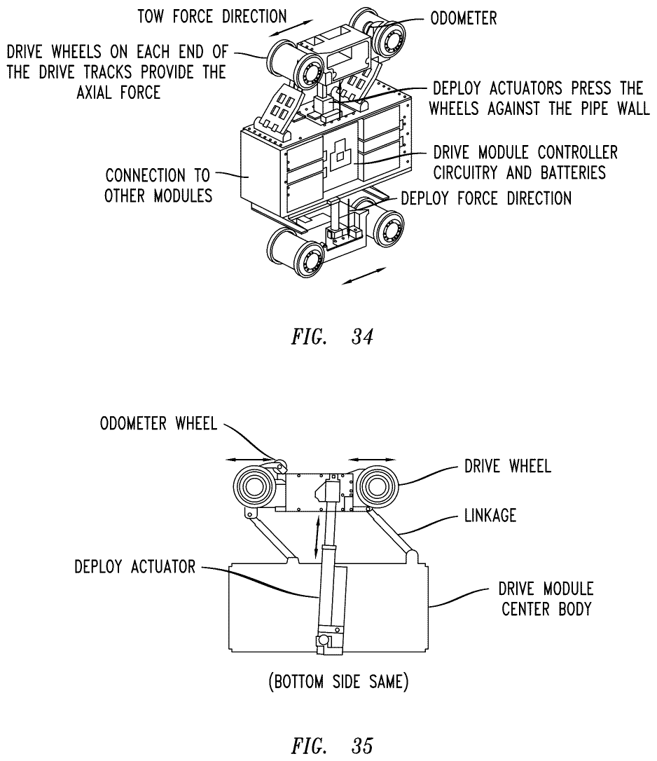

FIG. 34 illustrates, in a preferred embodiment of this invention, a drive module which is provided for moving the robot through pipelines measuring, by way of example only, 30-36 inches in diameter. A tow force is provided, both in horizontal and vertical sections. The drive module is designed to cause sufficient frictional pressure of its drive wheels against the inner pipe diameter surfaces to pull the relatively heavy robot.

This drive module preferably includes features comprising a main body, actuators, battery storage, odometers, automatic connection points, and control circuitry. Looking at each:

The main body includes two drive tracks on either side (one side shown in FIG. 35). These drive tracks contain two driven wheels (per side), which are treaded with urethane capable of providing sufficient friction to generate the required tow force mentioned above.

The actuators deploy the wheels onto the pipe wall. The deploy force is adjusted as the robot travels through the pipe to maintain constant friction for varying pipeline geometry. The drive module collapses down to 75% of the pipeline diameter (min. 22.5 in).

Battery storage accommodates re-chargeable battery packs. Batteries can be charged directly on the robot or replaced. To replace a battery, a quickly removable cover is provided.

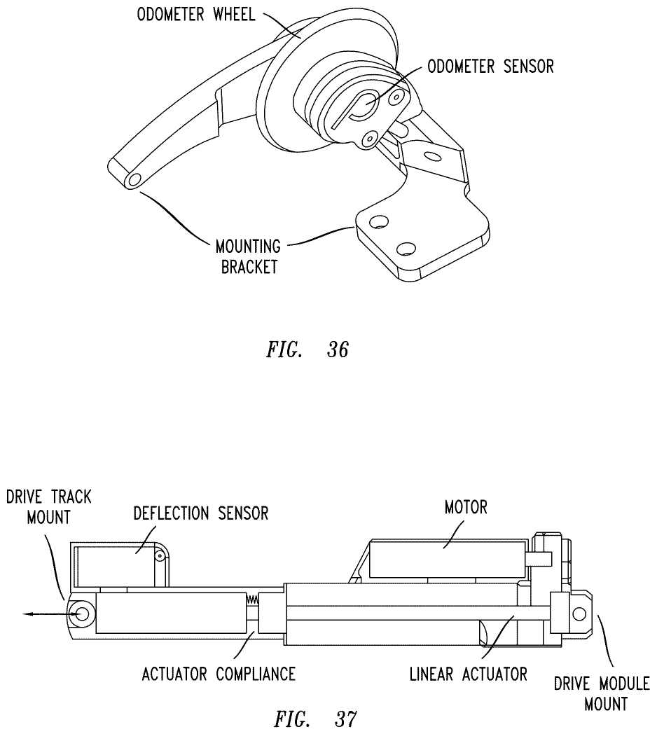

Odometers, one shown in FIG. 36 are installed on each drive track, and measure the travelled distance in the pipe. Each odometer wheel is specifically designed to cut through debris on the pipe wall and to eliminate slippage.

Automatic connection points are located adjacent modules, to eliminate the need for bulky wire-to-wire connectors.

Control circuitry is provided to enable communication to the robot nose and to operate all of the actuators which, in turn, deploy and drive the wheels.

FIG. 35 illustrates a main drive module body supporting a deploy actuator and drive track. The arrows depict relative degrees of movement. Moveable linkage connects the drive module center body with the drive wheel.

FIG. 36 depicts an odometer wheel on a drive track, and further identifies an odometer sensor. The deploy actuator, which presses the drive tracks against the inner pipe wall, is shown in FIG. 37. The deploy actuator contains a drive motor, which is connected to a lead screw via spur gears. The lead screw is connected to the opposite end of the actuator to provide the appropriate force throughout the entire stroke. The connection point is cushioned with a spring so that small deviations in the pipe wall can be absorbed. A deflection sensor monitors the compression of this spring and feeds that information back to the operator.

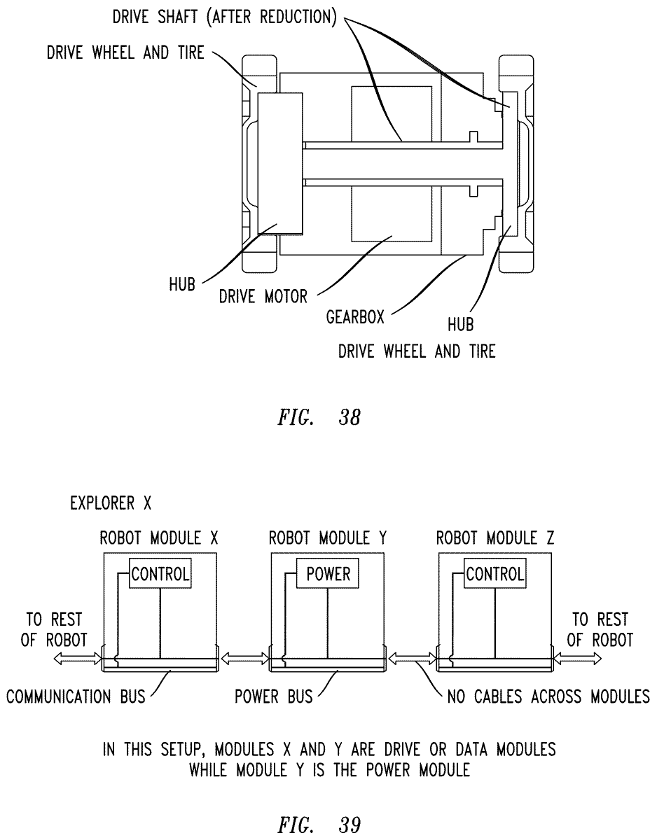

The drive wheel power transmission is shown in FIG. 38. A motor is housed in the center between the two drive wheels. The motor drives the hollow shaft, which is coupled to the gearbox. The hub is also connected to another shaft which transmits the torque from the gearbox back through the gear/motor combination to the other side of the assembly. Here the shaft is connected to another hub. A wheel is connected to this hub as well.

This design allows the motor to drive both sides of the drive track with the same high torque.

### Robot Battery Distribution:

The present invention contemplates the distribution of batteries in and among several modules. This is illustrated schematically in FIG. 39. To take full advantage of available volume for energy storage throughout the robot of this invention, batteries are distributed throughout the robot. This approach decentralizes the energy storage on the robot rather than having a central power module. Therefore, each module is connected to a power bus for the purposes of balancing power throughout the robot and for charging. Each individual power component in each module is configured to supply the power bus at a constant voltage, depending on the needs of the entire robot. If the power bus is supplied with energy for charging, each power section stores that energy by switching to a charging mode. This approach allows the robot to be charged without removing the batteries and allows the maximum amount of energy storage necessary to increase range. It also allows the rest of the robot to function if one module, for any reason, does not provide power or is taken offline.

### Further Aspects of the Present Invention

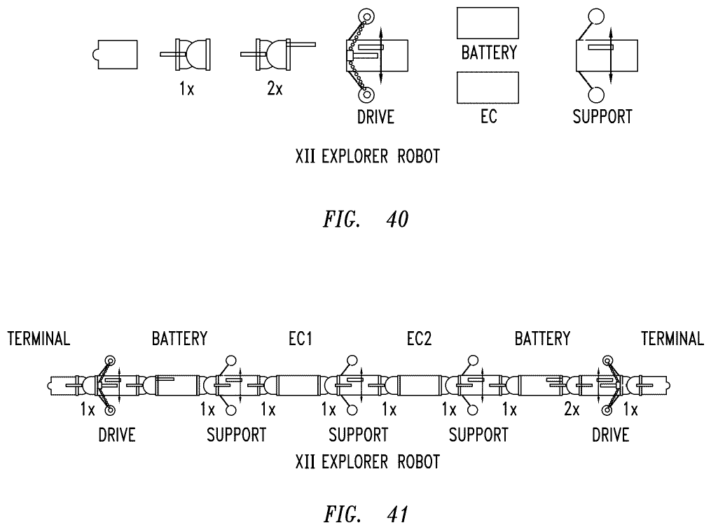

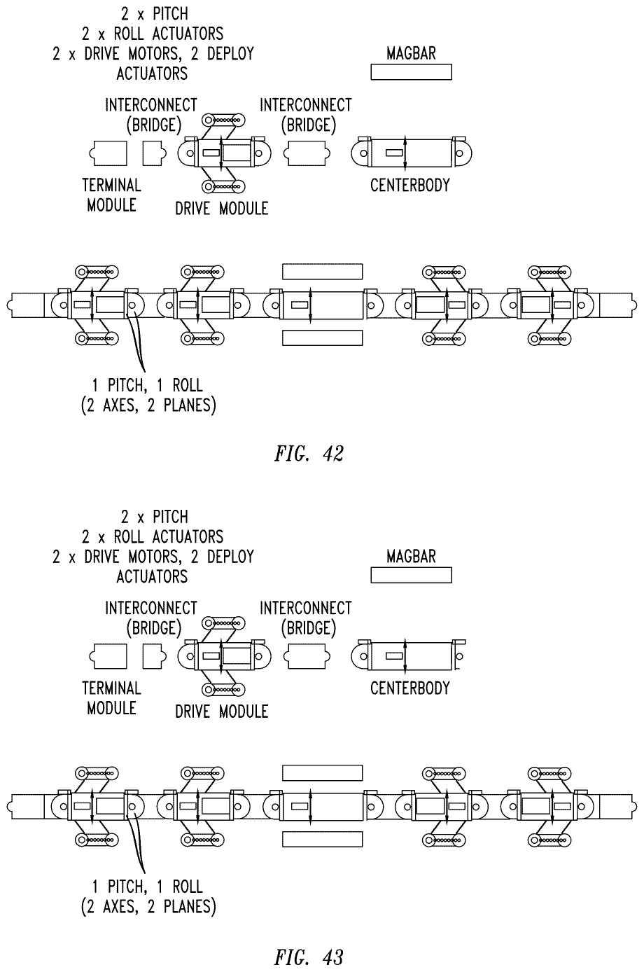

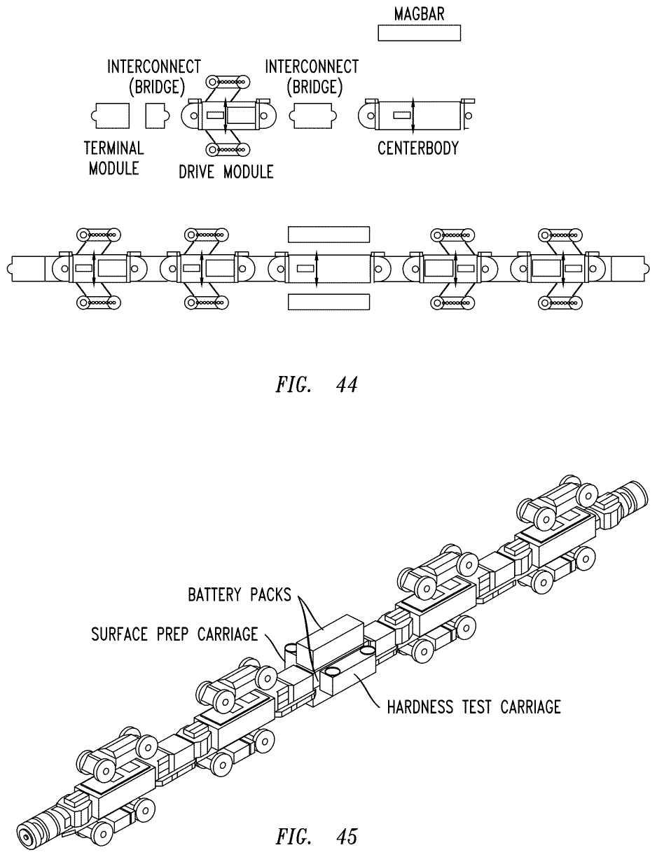

FIGS. 40 through 44 schematically illustrate robots which come within the scope of this invention. More specifically, FIGS. 40-41 represent, in general, a configuration of an inventive robot design. FIG. 42 illustrates a robot configuration suitable for an 8 inch diameter pipeline to be inspected. FIG. 43 illustrates a robot configuration suitable for 10 inch to 14 inch diameter pipelines to be inspected. FIG. 44 illustrates a robot configuration suitable for 16 inch to 36 inch diameter pipelines to be inspected.

### Conclusion:

The present specification and accompanying patent claims represent examples and various embodiments of the present invention, without compromising or departing from the broader scope and meaning of this invention. The invention is not to be limited to this literal discussion and the examples set forth herein. Other aspects and equivalents of the invention will suggest themselves to those skilled in the art, and will be embraced within the meaning and scope of the invention.

The Hardness Testing System: The present invention includes the following hardness testing capabilities.

### Approach:

As has been stated, a robot testing system has been tested and successfully marketed under the name and trademark “Explorer” by the Invodane company. As elsewhere throughout this patent application specification, an attempt has been made to present the reader with a description of the present invention on its own, without unnecessary reference to the Explorer robot system. In the case of the hardness tester of this invention, however, an approach has been adopted to place a hardness tester module (HTM) on the Explorer system, in order to be able to use as many existing robot components as possible.

The configuration of the HTM as finally adopted is illustrated in FIG. 45. The concept for the in-pipe hardness tester module calls for two units (sub-modules), the surface prep carriage and the hardness tester carriage. Since the surface prep tool is exhausting fine particulates into the gas flow, a design effort has been made to keep the two functions substantially isolated from each other. Both units are protected from debris build up when not in use.

The surface prep surface prep carriage (Error! Reference source not found.) was designed with the following features:
A carriage that is deployed to the pipe wall and can be retracted to satisfy a 75% restriction requirement of Explorer. The carriage may remain deployed on the pipe wall for the duration of the run, depending upon the cleanliness of the line, features, etc.
At the front of the carriage is a spring-loaded scraper to perform the function of removing loose debris from the selected region (where the tests will be carried out).
The preparation of the surface is carried out in two-steps; a first step uses a wire brush to provide a coarse cleaning of the surface, followed by a finishing tool (for sanding) to provide a fine cleaning of the surface.
A wire brush system can be deployed to the pipe wall at a 15-deg tilt. This is capable of operating in parallel with the scraping operation.
A camera and light are included in order to evaluate the surface of the inner pipe wall after the wire brush cleaning step. The operator is able to visually detect dents, seam weld, or other surface features that may prevent a good hardness reading. The camera image is recorded to have a comparison with the post surface prep image.
The surface finishing tool is mounted on an actuated slide to control the axial motion and pressure, in order to achieve a desired surface finish.
A wall thickness probe or similar device monitors the progress of the material removal with the sander.

The hardness measuring carriage (FIG. 47) was designed to contain the following features:
The carriage needs to be pressed against the wall with a force higher than the 100 kp required for direct Rockwell testing (Rockwell B).
A positioning camera is located at the front of the carriage. This is to position the carriage directly in-line with the prepped surface. The positioning camera will be inclined slightly forward to aid the operator in finding the prepped surface.
A macro camera with high resolution is used to inspect the entire prepped surface. This series of images are recorded. Field of view should be about 0.5″ with as high of resolution as possible.
The macro camera and direct Rockwell measurement are attached to a slide.
The hardness tester is engaged and takes a series of 10 measurements automatically, moving approximately 3 mm between each measurement. An image is taken of the indent automatically.

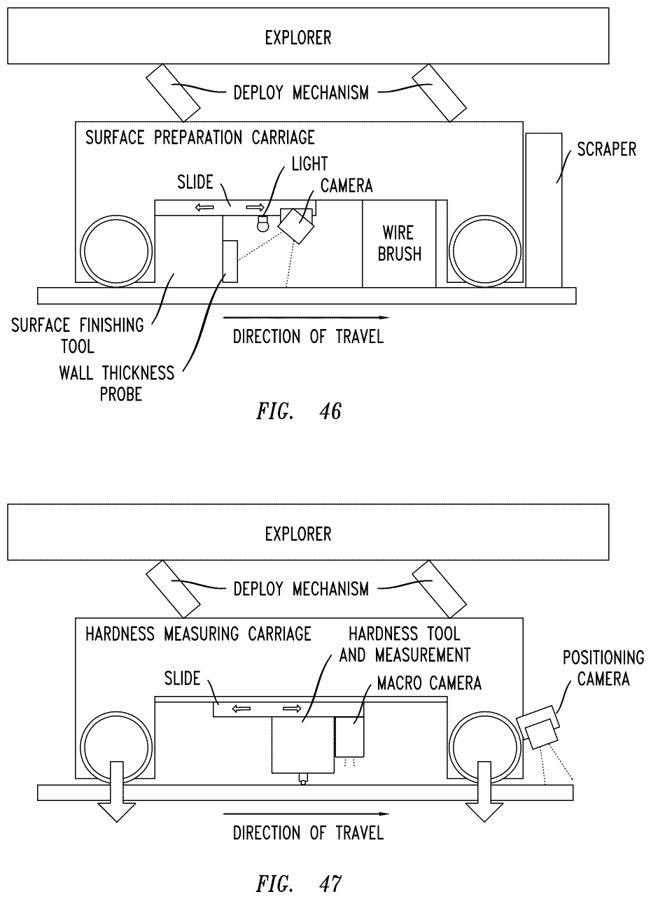

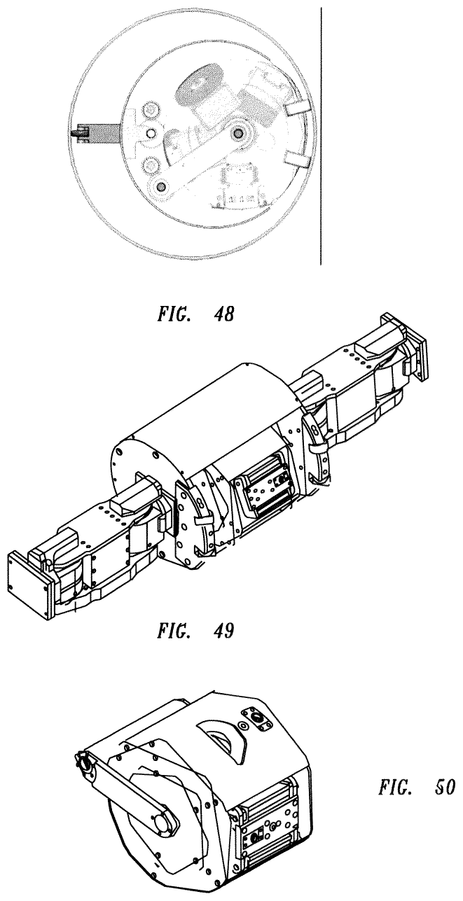

Development: The following is meant to serve as both an outline of the process undertaken to develop the hardness testing module, as well as a description of the module's features according to this invention. See FIGS. 48-49.
The module is located centrally on an Explorer robot in place of the standard MFL sensing section.
It is manipulated through pipeline features and can be positioned on the side of the pipe wall via existing modules on the robot.
It contains an actuator that clamps the sensing section to the pipe wall. The actuator is called the clamp actuator.
The module contains a drum that can be actuated parallel (feed actuator) to the axis of pipe as well as rotated (drum roll actuator).
The drum contains surface preparation and indentation features (or carriages as described above) that are moved into position in order to carry out the hardness measurements.

Hardness Test Drum: A hardness test drum (FIG. 50) has five positions. The positions contain the following components to carry out a hardness measurement of the pipe:

Wire brush wheel: The wire brush wheel removes loose debris from the pipe wall, which either drops to the bottom of the pipe, or is carried away by the gas flow around the module. The wire brush wheel axial movement is provided by the robot drive modules since the required preparation area exceeds the total feed travel.

Sanding wheel #1: Similar to the wire brush, the drum contains two sanding wheels. The purpose of the sanding stations is to accurately remove up to 0.010″ of material from the inside of the pipe and leave a surface finish appropriate for hardness testing. They are moved axially by the feed actuator. Each sanding wheel is fit with a camera and a depth sensor to monitor the sanding process during the operation.

Sanding wheel #1: Similar to the wire brush, the drum preferably contains two sanding wheels. The purpose of the sanding stations is to accurately remove up to 0.010 inches of material from the inside of the pipe and leave a surface finish appropriate for hardness testing. They are moved axially by the feed actuator. Each sanding wheel is fit with a camera and a depth sensor to monitor the sanding process during the operation.

In addition to the wire brush wheel, a camera and depth sensor are installed to both monitor and measure the height of the pipe surface before and after the wire brushing process.

Sanding wheel #2: Identical to sanding wheel #1, sanding wheel #2 position can be fit with the same grit of sandpaper or a finer grit depending on test conditions.

Direct Rockwell Indenter: The direct Rockwell indenter performs the hardness measurement on the prepped surface in a row parallel to the pipe axis by moving the feed actuator. The indenter also is fit with a secondary camera to take a close-up image of each indentation in the measurement set.

Home position: Contains control electronics for all measurement functions. Drum is rotated to this position when the module is not making measurements.

While a scraper is not provided in this specification, the invention contemplates its optional inclusion.

Overall System Presentation: The following describes in more detail the system's inclusion of a wire brush, sanding wheels, and an indenter:

### Wire Brush:

The wire brush position is used to remove any debris that is loosely adhering to the pipe wall. This is so that the sanding wheel and indenter remain relatively clean in what is normally a rather dirty pipeline environment. The wire brush aboard the HTM cleans a width of approximately 1.75″. The indenter contacts a portion of pipe that is approximately 4″ in width. Therefore, three passes of the wire brush (there and back) will normally be required.

Actuation for the wire brush preparation of the pipe surface is achieved by moving the robot. The robot is driven back and forth with the wire brush motor engaged. The whole module is rotated ±10 deg in order to achieve the full 4.25″ width of the wire brushed surface.

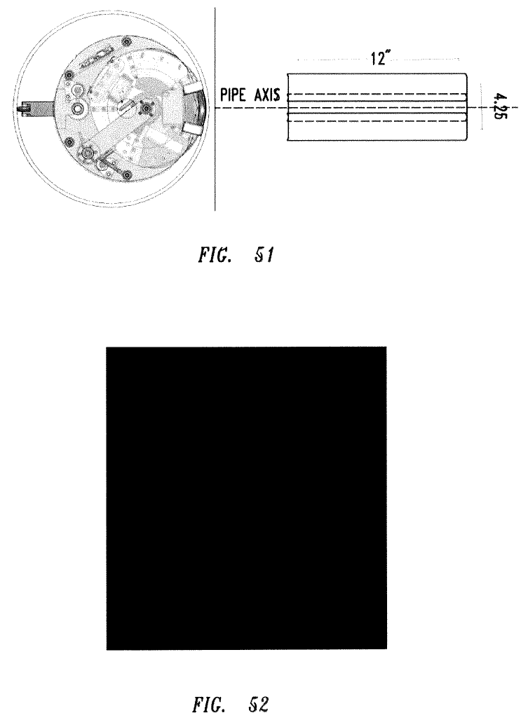

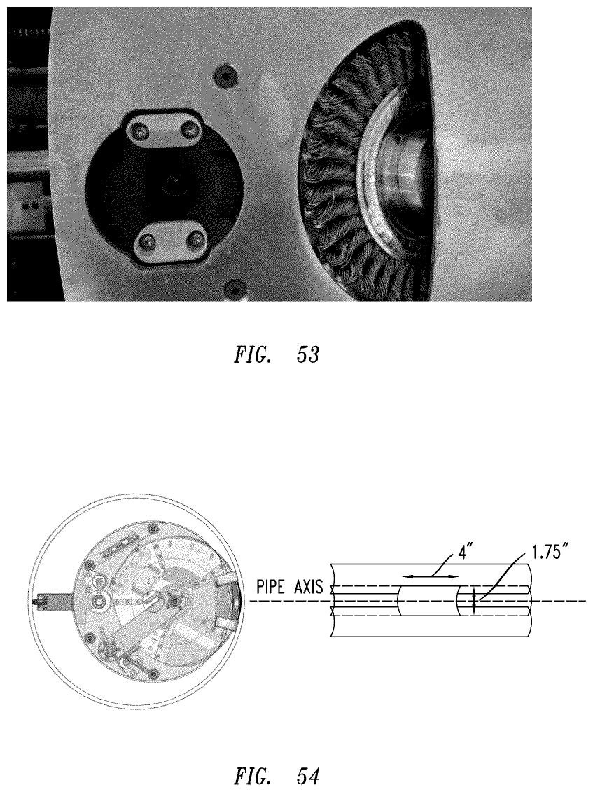

The wire brush used to remove debris from the pipe wall may be an off-the-shelf 4.5 in diameter stringer bead brush. The 0.020″ bristles are twisted together for aggressive cleaning of steel surfaces. The unit is intended for use on bench grinders, CNC machines, and/or angle grinders. Depending on the application, the wheel can be replaced easily on the module, as long as the diameter is 4.5 in. The wheel is spinning at approximately 1000 RPM which is significantly lower than the 15,000 RPM for which it is normally rated. The wire brush wheel position contains a camera that monitors the initial pipe wall cleaning process. If further passes are required, more passes can be performed at the operator's discretion. Wire brushed area dimensions are illustrated by FIG. 51. A wire brush of the type intended to be used is shown in FIG. 52. A wire brush prep wheel on a drum is shown in FIG. 53.

### Sanding Positions 1 and 2

In a similar way to the wire brush position, the drum houses two sanding wheel positions. The purpose of the sanding wheels is to remove 0.010″ of the pipe surface and leave a surface finish conducive to take repeatable measurements. Shown in FIG. 54, this zone is significantly shorter in length than the wire brushed surface. The width of the sanded surface is approximately 1.75″ with the most material removed in the middle. The length of the region is approximately 4″ long which is enough to accommodate between 15-20 properly spaced measurements (a minimum of 10 is needed and this allows axial distance to repeat measurements). Currently to remove the appropriate amount of material requires 4 passes with a 60 grit sanding head (there and back).

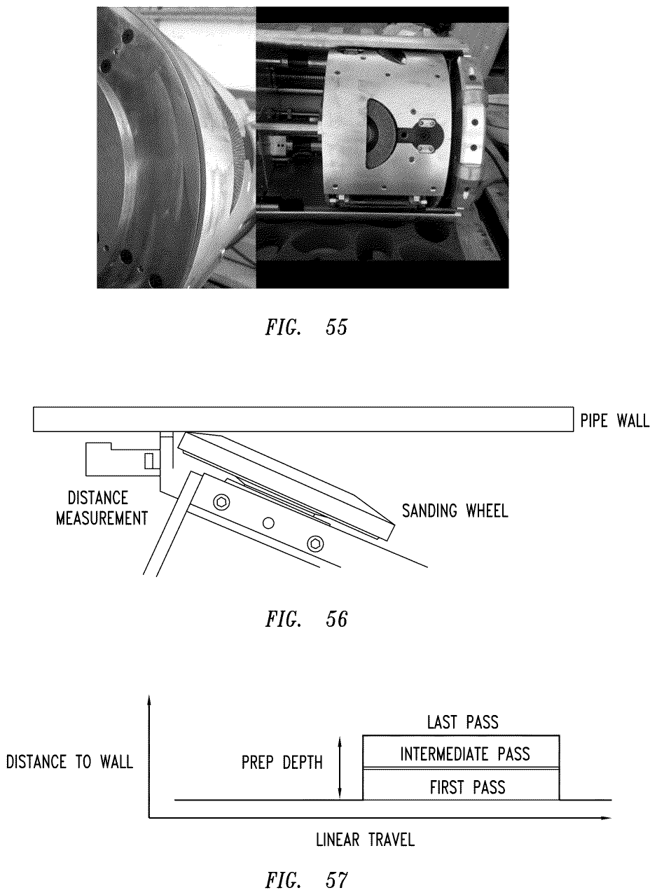

The sanding wheel used may be an off-the-shelf 4.5 in angled sanding disc made by layering individual fabric backed sandpaper. This standard disc can be purchased in various grits from 36 up to 120 grit and was selected during the feasibility study. The disc is mounted on an angle to the drum so that only a 1.75 in wide area is sanded. FIG. 55 illustrates a sanding wheel on a drum.

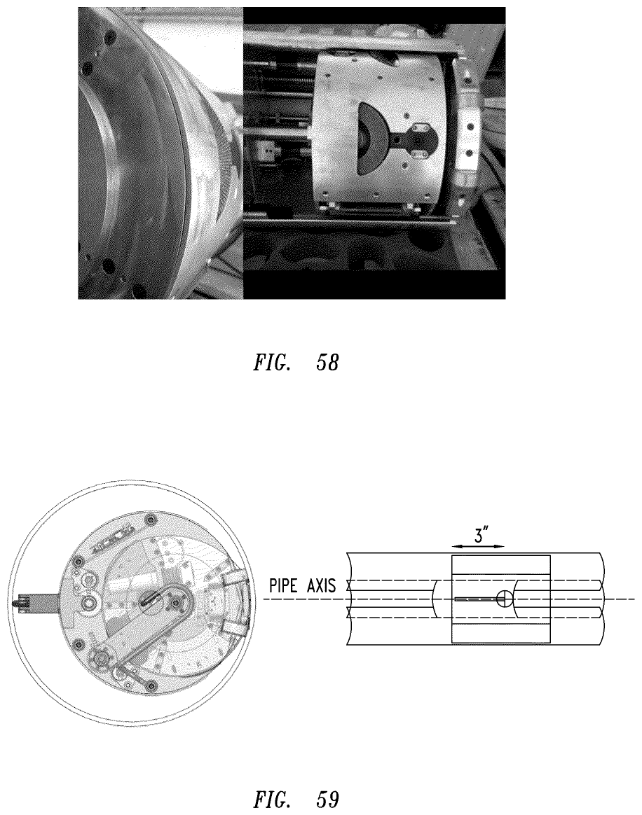

Accompanying the sanding wheel is a distance sensor (FIG. 56) and camera to monitor the sanding progress. The distance sensor measures the distance between the drum and the surface. Each time the sanding wheel makes a pass, the distance sensor records the relative depth of the preparation (see FIG. 57). When the appropriate depth is recorded, the preparation is stopped. This process has been tested (see FIG. 58) using a sanding motor and sensor in the pipe prior to integrating into the current design.

### Rockwell Indenter:

A fourth element on the drum houses the indenter unit. This unit indents the pipe according to a set loading condition along the prepared surface of the pipe. The indentations are made along the center of the prepped zone (see FIG. 59). As can also be seen from FIG. 59, the outline of the indenter element (red lines) fits within the wire brushed zone described earlier.

Test standards for hardness testers provide the following general guidelines for measurement using the Rockwell method on a portable unit (from CRTD Vol. 91):
The minimum wall thickness for direct Rockwell is 0.250″.
The center of the deformation to the edge of the next indent (or edge of material) should be more than 2.5 times the diameter of the indent. For mild steel, this means that a minimum of 2.5 mm should be kept between centers of the indentations.
For a portable tester to be considered equivalent to a laboratory result, the measurement should be within 96-102% of the lab value.
The coefficient of variation (COV) should not be higher than 0.07. This is calculated to be the ratio of the standard deviation to the mean of the ten measurements.
The measurement range should not exceed 10% of the mean value.

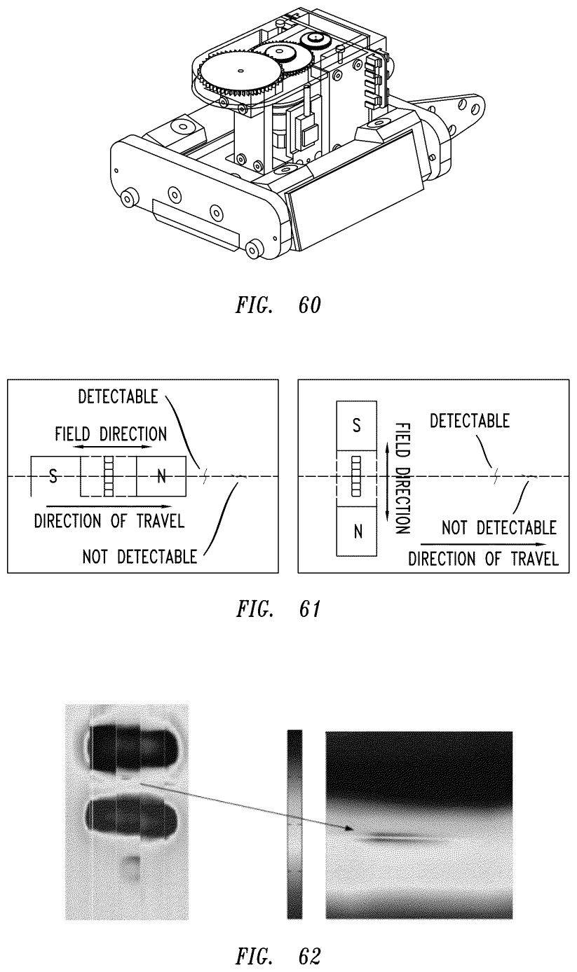

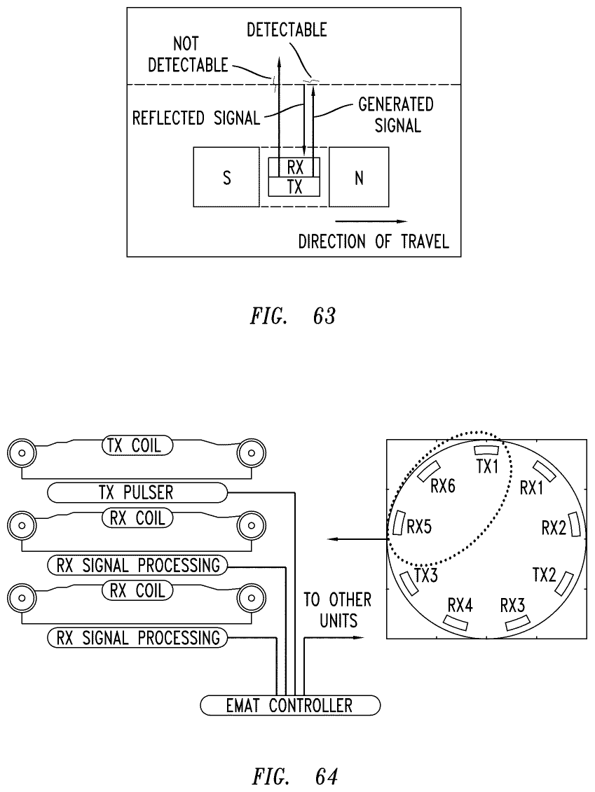

An indenter unit with electromagnets illustrated in FIG. 60. It consists of the following components:
The minimum wall thickness for direct Rockwell is 0.250″.
Electromagnets to hold the assembly on the pipe wall; this was proven to be crucial in being able to achieve the desired accuracy
A 1/16″ diameter tungsten steel ball indenter on the end of a linear actuator
Linear encoder capable of measuring an indentation of 60-120 μm (1 μm resolution)
Load cell up to 100 kgf with 0.1% resolution
Control circuit board

The unit itself is designed to provide proper load magnitudes, contact velocity, and dwell times specified for the Rockwell B scale (ASTM E18). Rockwell B scale was used since it can be directly converted to yield strength values in CRTD Vol 57. The loads for this scenario are described in the following table:

| Parameter | Value | Unit |
|---|---|---|
| F₀ | 10 | [kgf] |
| F₁ | 100 | [kgf] |
| Indenter size | 1.588 | [mm] |

The steps to be taken in order to obtain a direct Rockwell measurement with the indenter unit developed here are as follows:
Position unit and turn magnets on
Load indenter to 10 (F₀), zero the depth reading.
Load indenter up to 100 (F₁)
Unload indenter back to (F₀). Take the depth measurement which gives the Rockwell hardness value.

### Transverse Magnetic Flux Leakage (TMFL):

Existing sensors on the Explorer robot are able to determine the metal loss profile of the pipe for losses. The Magnetic Flux Leakage (MFL) sensor on the current Explorer tool magnetizes the pipe wall in the axial direction. One of the areas with reduced sensitivity for this arrangement is axially aligned anomalies, such as cracks. By rotating the magnetization 90 degrees as shown in FIG. 61, also known as transverse magnetic flux leakage (TMFL), detection of axially aligned cracks can be achieved.

Data from experiments shown in FIG. 62 illustrates the detectability of a crack using a circumferential field. The north (red) and south (blue) poles are shown across a defect of 42% depth in a 0.250 WT plate. The color plot shown indicates the radial hall sensor reading in the vicinity of the crack, obtained by directly measuring the radial field vector along the surface of a plate. The crack signature can plainly be seen.

The preferred approach for a TMFL sensor is to achieve full coverage of the pipe circumference on the shortest module length possible. The crack sensor uses two sets of circumferential bars. There may be some reduction in field strength due to the proximity of the sensing sections to each other, but for crack detection this is acceptable. Tests similar to FIG. 62 show the detectability of cracks even in the region around the edge of the magnet poles.

### Electromagnetic Acoustic Transducer (EMAT):

EMATs (Electromagnetic Acoustic Transducer) bring ultrasonic methods to applications where an acoustic couplant, usually a gel or water, between the transducer and the test article cannot be used. This is the case in gas pipelines where application of liquid on the interior of the pipe is not desirable. An EMAT requires a magnetic field in the base material, along with a pulsed coil that causes an acoustic pulse to travel through the material.

Implementing an EMAT sensor on Explorer involves establishing a suitable magnetic field for generation of the acoustic pulse that travels around the pipe circumference. In the magnetic field are coils or windings that are riding as close to the pipe wall as possible, which transmit and receive this electromagnetic pulse. These components and their corresponding electronics need to be packaged in a manner that is suitable for pipeline conditions. The physical components required for EMAT data acquisition are summarized as follows:
(1) Magnetic field: A magnetic field is required in conjunction with an electrical winding. The magnetic field is substantially perpendicular to the direction of wave travel. An oblique angle can improve the magnitude of the signal.
(2) Transmitter pulser and coil: A combined system, a high voltage pulse is applied to the winding which excites the pipe wall with an acoustic pulse. The high voltage pulse used in this system is in the range of 500-600 kHz, depending on the geometry of the coil. The pulse is high voltage (300V peaks), however the overall duty cycle is low since this voltage is applied in bursts.
(3) Receiver coil and signal processing: Magnetorestrictive forces directly underneath the winding generate electrical signals as they pass through the solid. The first pulse seen is a direct pulse, which is the pulse as it travels through the pipe directly to the receive coil. Any response after the direct pulse is typically reflections off edges encountered in the pipe. These edges can be a seam weld, metal loss, or crack features. Data is stored to onboard flash for download into data analysis software.

EMAT Controller: For multiple transmitters, the pulses need to be ordered in such a way as to allow the pulse amplitude to attenuate before the next the pulse is generated. If more than one pulse is traveling in the circumference at any given time, the reflection path will have multiple peaks in the received signal. Therefore, the pulses generated by multiple transmitters, and the receivers used to detect reflections, need to be scheduled accurately. This is performed by an EMAT controller, which provides synchronization and scheduling for all of the transmit/receive units around the pipe.

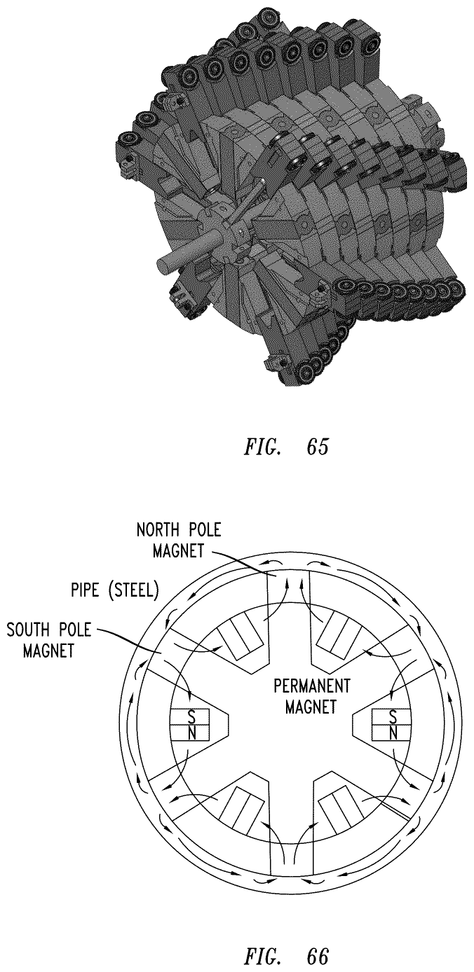

The EMAT components, transmitters and receivers can be arrayed around the pipe circumference as shown in FIG. 64. EMAT detection of cracks is illustrated in FIG. 65.

### System Design:

Crack Sensor: Two different technologies have been combined in order to detect axially aligned cracks in unpiggable pipelines. These technologies were EMAT (Electro Magnetic Acoustic Transducer) and TMFL (Transverse Magnetic Flux Leakage).

A key aspect of the sensing section is the requirement for a full circumferential field around the pipe wall. This field, during development, required many test setups. The sensing section consisted of 8-12 poles split in the model so that the hall sensors would cover the entire circumference.

The sensing section concept had a total of 84 individual poles separated into 6-spiraling sections, each with 10 poles. The sections were spiraled in a way that allows for full coverage with MFL sensors as shown in FIG. 65. Shown in a representative cross section of the spiraled sensor FIG. 66, each of the poles is actuated up and down from the center of the robot in order to achieve collapsibility. The magnets are turned on and off via a rotating magnet rotor inserted radially into the backing bar. FIG. 66 also illustrates that the direction of the magnetic field in the pipe wall is in the circumferential direction.

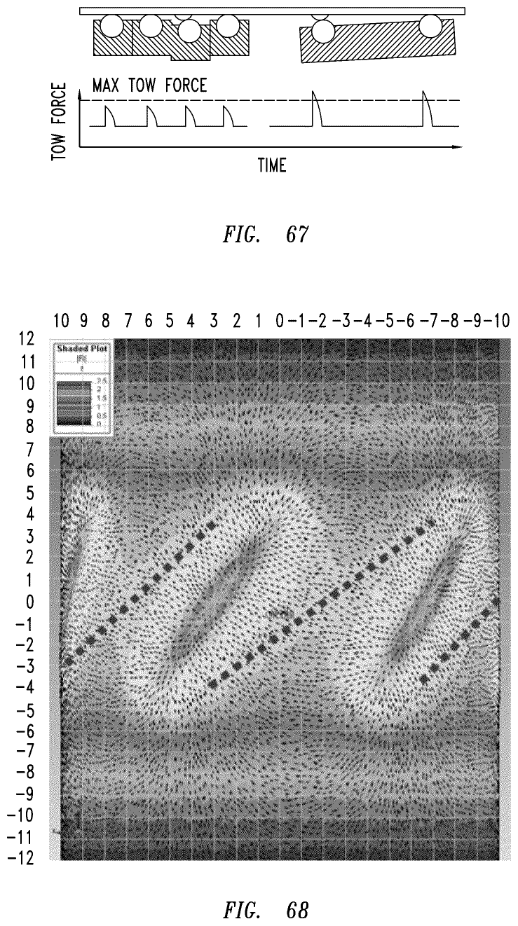

This configuration was required in order to reduce the tow force characteristics as well as increase the magnetic field strength in the pipe wall. Because of the increased number of poles, as the sensor travels over a feature such as a girth weld (welds connecting pipe segments together), each pole can ride up and over the feature instead of requiring the whole pole to move. This approach is illustrated in FIG. 67 and results in a lower peak tow force on the sensing section.

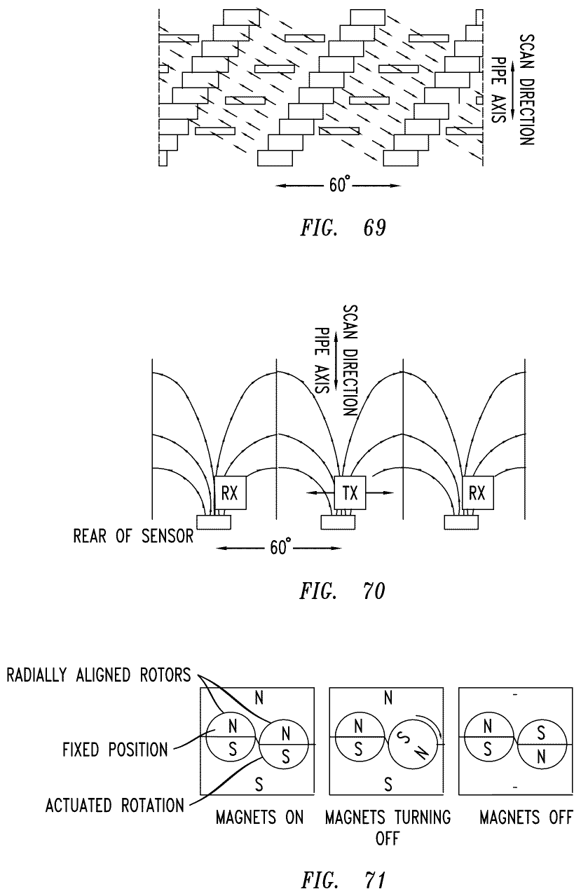

The magnetic flux was, during development, simulated for the configuration and is shown in FIG. 68. Each pole has a region of suitable magnetic flux magnitude where the hall sensors will be located. These are shown as the red boxes in the FIG. 68. As can be seen in this figure, these sensors overlap each other in the axial direction (vertical) between the sections. To implement this sensor layout, the sensors were grouped into four sensor elements and staggered along each bank as shown in FIG. 69. In FIG. 69, sensors are shown in purple overlapping for the entire circumference. Magnetic field direction is shown in grey arrows.

The EMAT sensors are located at each end of the pole where the magnetic field spreads in the axial direction (FIG. 70), which is necessary to generate circumferential shear waves. The shear wave direction (pink arrows) is circumferential around the pipe. The magnetic fields at the poles (grey arrows) spread out in the pipe axis direction.

The EMAT sensors preferably have three controllers which handle transmission and sensing functions for the acoustic waves travelling in the pipe. The transmitter has a pulse control module and a pulse driver module. The pulse control module converts the 24V into a high voltage source as well as switches the control lines of the pulse driver module. The pulse driver module takes the source and control lines to drive the coil at the desired frequency and duty cycle. Due to space constraints, the pulse driver and pulse control are situated at each end of the robot. There are two EMAT transmitters (control and driver pair) on the sensor. The EMAT receiver modules have a digital and analog portion which amplify, filter, and record the EMAT signal. There are preferably four EMAT receivers on the sensor.

The poles are able to be retracted down to the minimum diameter of the robot so the sensor can be turned around corners in the pipe and into the hot tap used for launch and extraction (see FIG. 66). Before moving the poles, the magnets need to be turned off. The magnetic field is controlled using a rotor pair concept shown in FIG. 71. The rotor pair has a fixed magnet and a rotating magnet (see FIG. 71). When the rotors are facing the same way, the magnets are on. When one is turned 180 degrees, no magnetic field exits the block.

Magnet pairs are contained in a backing bar and are spiraled along the length of the sensing section FIG. 74. The rotors are actuated from each end to turn the magnets on and off. The backing bars are also form a sliding surface for the magnet poles during extract and deploy.

The overall system can be seen in FIG. 73. One set of poles and one set of backing bars are shown. Poles are actuated from a central gearbox in the middle of the crack sensor body. The pole actuator gearbox has 30 points which connect with 30 poles to drive radially outwards to the pipe wall. The rest of the poles are linked to the driven poles. The shunt mechanism is driven from each end by for each of the six magnetic sections for a total of twelve motors. Both the pole-deploy and shunt motors are controlled from two motor controllers on each end of the sensing section. Power control, communication, and EMAT synchronization are also controlled from each end of the sensing section. All of the control boards are attached to two connector boards on each end of the sensing section. Motors, sensors, and other peripherals are attached to the connector boards to simplify assembly, testing, and debugging.

The steer module attached to each end of the crack sensor contains the support wheels which support the weight of the sensor during inspection. Because of this support method, the tow force of the crack sensor is further reduced to levels comparable to the conventional axial MFL system currently towed by Explorer. All new components were individually pressure tested to 750 [psi] to ensure operation in live testing.

Overall, the new crack sensing section consists of the following components:
6 collapsible magnetic pole sections that contact the pipe wall. Each pole e section would have up to 10 poles.
Each magnetic pole is spiraled to achieve full coverage of the pipe circumference
Hall sensors are placed between the poles to measure magnetic flux leakage.
2 EMAT transmitter and 4 EMAT receivers are positioned at the ends of the poles
The magnetic section is supported in the pipe with collapsible rollers at each end
Customized steer modules pitch and rotate the crack sensor through the pipe

The crack sensor analysis tools are the functions and methods used to organize the data for viewing and ultimately sizing anomalies identified in the data. The data is collected and organized separately until it is viewed side by side in the viewing software (commercialized under the name DataTel). There are four main types of data collected by the robot during a scan with the crack sensor. First, navigation and robot configuration is recorded when the robot is in the pipeline. From this data, the analyst can determine the robot position and possibly other indications of defects such as markings on the inside of the pipe. Second the robot collects MDS (Mechanical Damage Sensor) data using the three cameras and laser ring on the rear of the robot. This process is described in the previous section. Third, the crack sensor collects TMFL data on 24 individual sensor elements arrayed around the pipe wall. This data is stored directly on the sensor elements and downloaded at the end of the inspection. Fourth, the EMAT data is collected and stored aboard 4 receivers arrayed around the pipe wall.

Robot Configuration: As currently designed, the entire configuration of the robot collected from angle and position sensors throughout the robot are recorded during a run. Along with battery level, power status, communication strength, etc, the position of the robot can be reconstructed after a run. This is done using a parser that extracts and plots different variables from the robot log files. The log files also contain the odometer information for the robot which track its position in the pipe. This information is used to define a scan and, in this way, the raw data is broken up into segments for pre-processing. The scan definition includes a time and spatial synchronization step that aligns and maps all data to a particular location in the pipe. For the robot configuration data, once the scan is defined, the parameters are setup in the viewing software to access particular locations in the log file to view video and robot position automatically. While sizing is not performed explicitly with the robot configuration, some indications on the inside wall can be seen including girth welds, debris, discoloration, manufacturer markings, large dents, and even large patches of corrosion. These inputs are used to corroborate other data from the MDS, EMAT and TMFL sensors.

Transverse Magnetic Flux Leakage: The TMFL data handling is integrated into the viewing software during the implementation process. The data handling of TMFL data is consistent with Axial MFL techniques. The hall sensor data is collected and stored in a similar way, the data is spatially sampled using the same scripts, and the resultant data files for input into DataTel are the same. DataTel has been modified slightly to differentiate between TMFL and axial MFL data using the configure robot at startup.

Three main differences between the response of TMFL data and the axial MFL data are:
(1) TMFL data is sampled using only the radial component of the flux leakage pattern. This means that the behavior of the signal will be more sensitive to the sensors lifting off the pipe wall than in the conventional sensor. The pattern of the signal will be similar as the axial case.
(2) There are four sensor elements in each bank, staggered to achieve full coverage. Because of this, there is a slight overlap on the sensors. This overlap needs to be accounted for during pre-processing.
(3) The sensor elements are offset from each other along the pipe axis. This means that they measure a different area of a pipe at a different scan position. This requires the analyst to shift the readings which respect to each other when spatially aligning the data.

FIG. 74 schematically illustrates the handling of crack sensor and MDS.

A main obstacle encountered with the TMFL sensor has been the calibration of the sensors, and the development of a sizing algorithm capable of determining how deep cracks are once they have been detected.

### Electromagnetic Acoustic Transducer (EMAT):

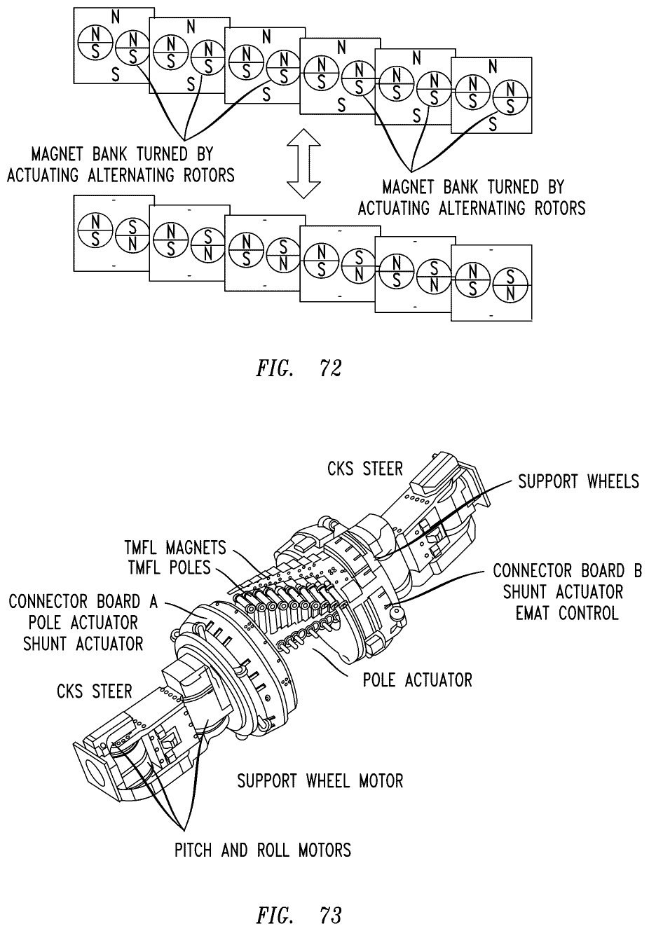

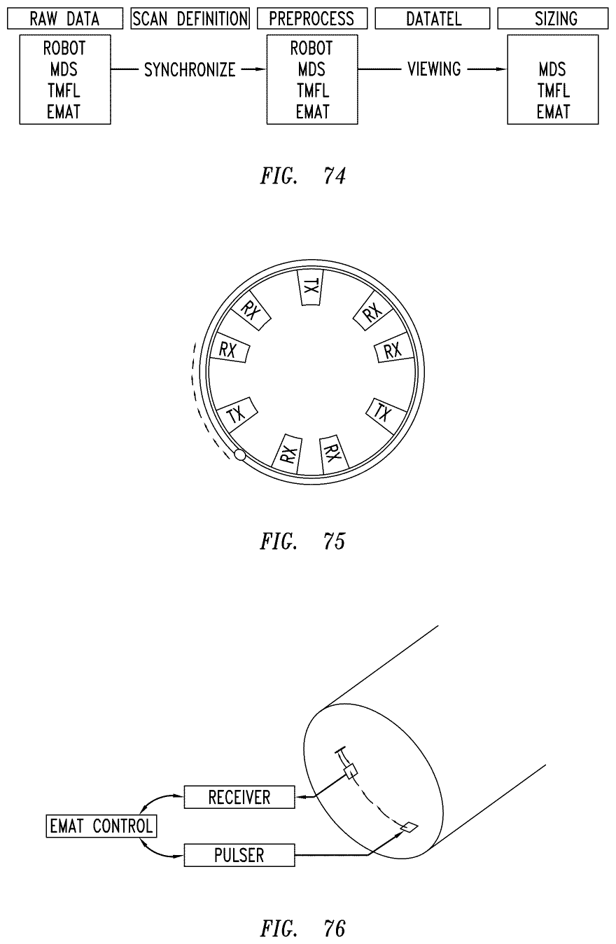

The crack sensor collects EMAT data from multiple receivers around the pipe wall responding to pulses generated by multiple pulsers. This data is stored aboard the EMAT receivers directly as samples. Each pulse generates one sample on each receiver. A sample of an experimental unit used for testing is shown in FIG. 75. The graphic shows a cross-section of a pipe with pulsers (transmitters shown in pink) and receivers shown in gold. There are two receivers between any pair of pulser. The arrows along the wall of the pipe show the direction of the generated shear wave. A typical wave that is picked up by the receiver is shown in FIGS. 76 and 77. In the ultrasonic inspection industry, this is known as an amplitude modulation scan or, A-scan.

Direct pulse—This is the very first wave that the receiver can detect and is the highest in amplitude. It is the shortest path between the transmitter and the receiver. This pulse can be attenuated by the presence of features such as wall thickness changes, seam welds, and/or defects.

Feature reflection—Reflections of the wave off features are read by the sensor at a later time than the direct pulse because they need to travel a longer distance. These can come at any time after the direct pulse and are usually smaller in amplitude.

First round travel—These are the same direct pulse after one complete revolution around the pipe. These occur in pairs since the transmitter emits a pulse in both directions. One pulse travels a shorter distance since the transmitter and receiver are not at the same location.

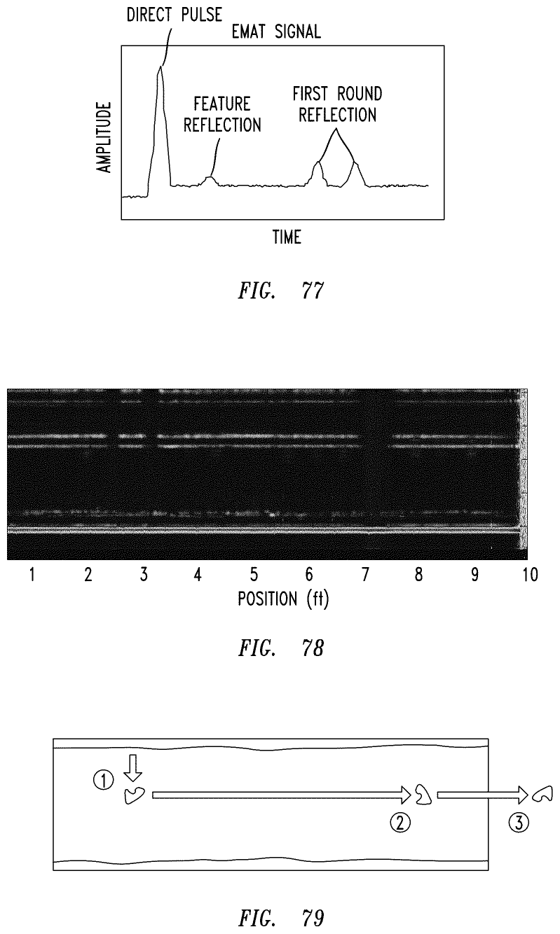

If sensor is moved through the pipe and sampled at discrete points, then the signals can be stacked up next to each other. The distance is plotted on the x-axis and the time is plotted on the y-axis. The amplitude is plotted on the z-axis or through colors of a contour plot. A sample of this plot is shown in FIG. 78. The direct pulse is the highest value and is shown as the consistent line on the bottom of the plot. It is straight because the distance between the pulser and receiver are fixed by the test apparatus. The next line that can be seen is the reflection of a seam weld. The round trip travel double peaks can be seen later on in the signal.

A real time data view has been implemented for EMAT aboard Explorer to allow the operator to evaluate the quality of the signal during an inspection.

In the current embodiment of the present invention, described here, there is a capability to process data from all EMAT channels on the sensor, spatially sample and analyze the magnitudes of the channels.

### Pipeline Cleaning:

Many different technologies and techniques are used to prepare pipelines for assessment with inline inspection tools. Applying these technologies involves planning and execution of often multiple cleaning runs to ensure the pipeline wall is free from buildup and debris. A clean pipe wall is important for inline inspection because measuring metal loss usually means positioning sensors near or directly on the inside of the pipe wall. Furthermore, cleaning the pipe usually means savings for the pipeline operator in terms of operational costs associated with equipment reliability and efficiencies in product throughput. When the pipeline cannot be pigged by conventional means, specialized robots are used to navigate the pipeline. While the means to move through the pipe may be drastically different, the sensing technology still needs access to the pipe wall for optimal sensitivity. Methods to combine these known technologies for cleaning unpiggable pipelines have been evaluated by InvoDane Engineering (IE).

To understand how to apply cleaning techniques to unpiggable pipelines, the following approach is employed: (a) Evaluate current cleaning methods used before inline inspection; (b) Evaluate current capabilities for unpiggable pipeline navigation using Explorer; (c) Develop general cleaning requirements; (d) Evaluate unpiggable cleaning concepts configurations.

### Pipeline Cleaning Background:

Pipeline cleaning can be categorized into three basic functional steps (see FIG. 79). First the debris or buildup is removed from the pipe wall. This can be done through a variety of means such as scrapers, brushes, and/or ploughs and can be aided through other means such as pressure jets or chemicals. Next the particles/debris from the pipe wall are transported through the pipeline. Finally, the particles/debris are removed from the pipeline environment via a pig trap, process equipment or in some cases, a suction pump.

### Unpiggable Cleaning:

From generalized requirements and the available cleaning technologies, it is possible to evaluate the range of technologies for pipeline cleaning available and to determine which are suited for unpiggable cleaning. The Explorer technology may be used as the base for the platform to be developed for pipeline cleaning in unpiggable lines.

Generally, any method that involves use of a product in a liquid phase has not been considered, since the addition of liquids into the pipeline requires follow-up “cleaning” to ensure that they are removed. Magnetic debris, which will be picked up by the sensing section (MFL sensor) of the inspection tool and can cause problems, can be removed with another set of magnets if required. This leaves brushes and scrapers as the available technologies to use on the robotic platform for pipeline cleaning.

The configurations used in unpiggable cleaning are applied both to pipeline sections that have flow and sections that do not. The limit of the applicability of each configuration is determined through testing and by the parameters of the individual pipeline.

Using constraints listed above, the current Explorer technology is used in part as the technology to build upon to achieve unpiggable cleaning. Thus, wireless control and self powered operation is maintained.

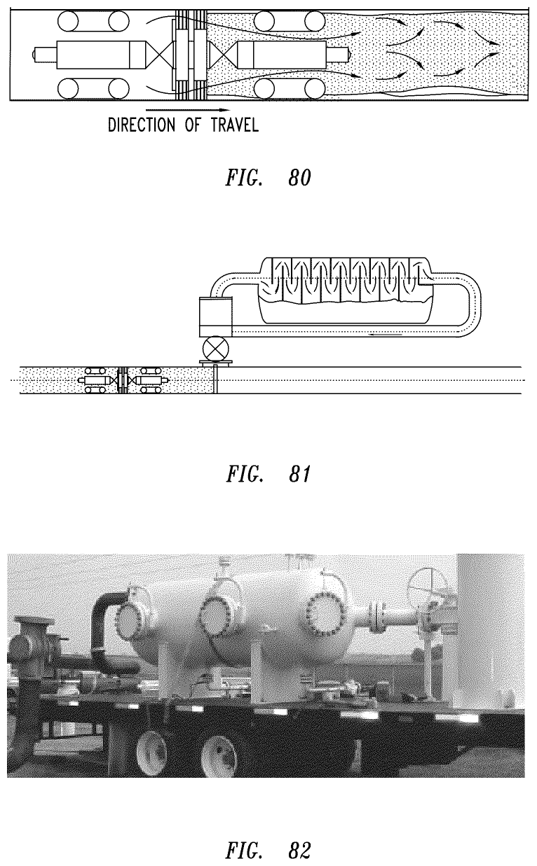

Unpiggable Cleaning With Flow: In this configuration the cleaning module (to remove debris from the wall) is placed in between two drive modules (see FIG. 80). The cleaning module is responsible for removing the debris from the pipe wall. Various cleaning sections are be employed for different debris scenarios. Cameras are installed to monitor the cleaning progress and to provide the operator with a predetermined degree of control over the cleaning process. A foldable restriction may be located on the tool that will cause a pressure differential across the tool. The primary purpose of the restriction is to create a jet to suspend the debris in front of the tool, not for directing at the wall of the pipe to detach the debris. Care is taken in the deployment of this device since a small pressure drop will create a large force on the tool. This differential pressure will be used to “energize” the flow and propel debris towards the front of the tool.

Cleaning performed by the bristles and scrapers when the tool is travelling with the flow. The force created by the differential pressure used to create the flow jet may also provide a thrust force to the tool, aiding in the energy required to pull the cleaning module through the pipe.

The technology to be used will evaluated in the context of buildup of debris and its operational impact. Visibility will be a concern. The cleaning tool may use a similar launch arrangement as the current Explorer. Other ancillary functionalities such as inline charging, and rescue tools may also be applied to this system.

The cleaning module is configured to fit through a plug valve geometry for pipe sizes 20-36 inches. Cleaning is thus possible through elbows and tees. Miter bends are cleaned along the path of the tool, contacting most areas of the bend. In a 90 degree miter case, a portion of the outside corner may be left untouched, as it would with the inspection robot.

With the debris removed from the pipe wall and suspended in the gas flow, a debris cloud will form and continue down the pipe. How this is handled is determined by the configuration of the pipeline. Options include the following: (a) The debris continues down the pipeline until it settles outside of the inspection area or where it can be cleared using conventional cleaning pigs; (b) The debris continues down the pipeline until it reaches a standard receiving chamber or separator. This is a case where the tool is cleaning a tee branch into a main line with conventional pigging facilities complete with gas-solid separators; (c) A portable gas-solid separator unit is installed on the pipeline at a downstream hot tap. The flow is redirected into the tap, through the separator (see FIG. 81), and back into the pipeline at a second hot tap located downstream or special re-direct in the same hot tap. For larger pipes, multiple separator units may need to be installed. FIG. 82 illustrates a portable separator for blowing down well heads.

Unpiggable Cleaning with Normal Flow:

To develop suitable operational cases for tool configurations, the number of hot taps needs to be minimized since for unpiggable pipes the available options for hot tap location are limited. The distance between the hot taps, as in the case for inspections, is determined by the tool range. A representative unpiggable line is shown in FIG. 83. It demonstrates the following cases: (a) A flowing pipeline with unpiggable features (blue); and (b) A no flow line with unpiggable features (red). All of the lines are pressurized to pipeline pressure.

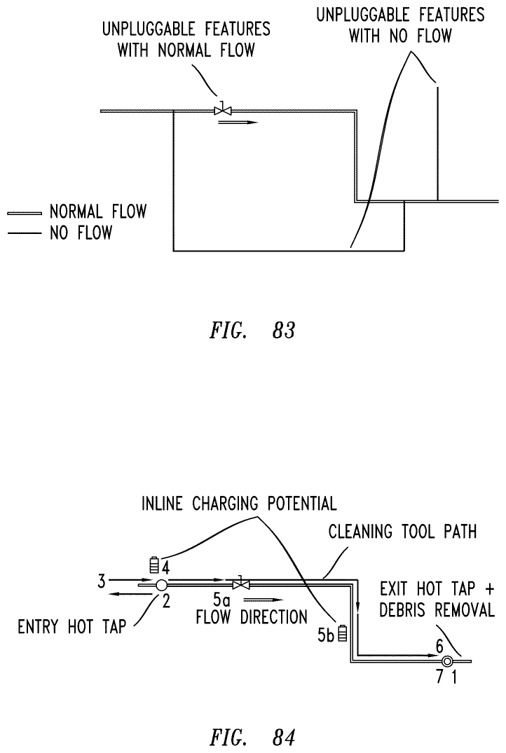

Two mission profiles (operating conditions) are considered for the representative unpiggable line. For the unpiggable cleaning with normal flow case, the tool path is shown in orange arrows, starting at the upstream hot tap (location 2). The gas-solid separator is installed at location 1 on the right side of the diagram. Flow through the section to be cleaned is from left to right, through unpiggable features such as a plug valve and mitered bends. Charging points for the tool are at the upstream hot tap and potentially midway points throughout the section to be cleaned (5b). The steps for cleaning the pipe section are described below (see numbered locations in FIG. 84 for each step).
a. The gas-solid separator is installed on the downstream hot tap of the section to be cleaned
b. The tool is launched through the upstream hot tap. Note that if the tool is launched from location (1), only one hot tap may be required for inspection as long as the cleaning occurs upstream of the gas-solid separator.
c. (optional) The tool is driven upstream and cleans back to the original hot tap.
d. The tool is recharged.
e. Cleaning steps: (a) The tool travels and cleans downstream through unpiggable features; (b) A charging location through a 2 in hot tap may be required between the upstream and downstream hot taps according to inline charging specifications. The tool would travel until it either reached the end hot tap, or a charging location. The tool is re-charged if needed.
f. The cleaning steps are iterated as necessary (5a-5c)
g. The tool travels and cleans downstream ending up at exit hot tap. At this point the gas-solid separator is detached from the pipeline and the debris removed and disposed.
h. The launcher is installed and the tool is unlaunched.

During cleaning run, the tool can be reversed to return to any location that requires additional cleaning. The entire section to be cleaned may be passed with the cleaning tool multiple times if the buildup is especially thick. With this ongoing operation, the debris can be removed from the separator either during or after operations.

### ILLUSTRATIVE PATENT CLAIM

An autonomous robotic unpiggable pipeline testing system, comprising, in combination, one or more of the following:
Means for reducing conventional inline pipeline testing operational complexity and providing unique and novel means for pipeline testing, including:
A novel computerized autonomous robot system,
Energy harnessing means for utilizing the flow of gas within a pipeline to operate turbine means, robot towing capabilities, and the charging of batteries,
Novel drive means,
Novel barrier means,
Automation computer means,
Novel feature recognition means,
Novel obstacle detection means,
Novel bend detection means,
Novel tee detection means,
Pipeline mapping means,
Novel plug valve navigation and functionality means,
Novel robot battery distribution,
Novel hardness testing means,
Novel transverse magnetic flux leakage sensing means,
Novel electromagnetic acoustic transducer means,
Novel crack sensor analysis means, and
Novel pipeline cleaning means

1. An autonomous robotic active gas-carrying pipeline testing system, comprising:
a remotely controlled robot assembly movable within a stream of gas flow in a pipeline, said gas flow exhibiting a dynamic flow energy, and
a differential pressure controller for monitoring a differential pressure and regulating a tow force for moving said robot assembly in a direction of flow, said differential pressure controller comprising a selectively expandable and collapsible barrier, said barrier expanded to increase flow blockage and retracted to decrease flow blockage;
wherein said barrier comprises two halves,
each half comprising a motor for driving a set of petals, each of the petals comprising
a flexible outer seal that changes shape in order to contact the pipeline, and
a rigid portion attached to an actuation gearbox,
wherein turning of the motor causes the actuation gearbox to rotate the petals from a collapsed position to an expanded position.

2. (canceled)

3. (canceled)

4. The system of claim 1, wherein said barrier provides coarse differential pressure.

5. The system of claim 4, further comprising an adjustable pressure regulator valve for fine tuning the differential pressure and providing overpressure relief.

6. The system of claim 5, further comprising a speed control system that monitors a travel speed of the robot assembly, wherein
if the robot assembly is travelling too slow, the barrier is caused to increase the differential pressure to increase the tow force, and
if the robot assembly is travelling too fast, the barrier is caused to decrease the differential pressure to decrease the tow force.

7. The system of claim 6, further comprising an electrical shunt for dissipating excess electrical power.

8. The system of claim 7 wherein the electrical shunt comprises a bank of resistors.
